(19) United States
(12) Patent Application Publication
(10) Pub. No.: US 2019/0355492 A1
(43) Pub. Date: Nov. 21, 2019

(54) COMMUNICATION CABLE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Ryoma UEGAKI, Yokkaichi (JP); Kinji TAGUCHI, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/480,387

(22) PCT Filed: Feb. 1, 2018
(86) PCT No.: PCT/JP2018/003423

§ 371 Date: Jul. 24, 2019

(30) Foreign Application Priority Data
Feb. 1, 2017 (JP) 2017-017103

(51) Int. Cl. H01B 7/26; H01B 11/12; H01B 7/24

(52) U.S. Cl. CPC H01B 7/26; H01B 7/24; H01B 11/12

(57) ABSTRACT

A communication cable that includes a communication line that includes a pair of insulated wires that each include a conductor that has a cross-sectional area of less than 0.22 mm² and an insulating covering that covers an outer periphery of the conductor, wherein the communication cable has a characteristic impedance in a range of 100±10Ω, and a difference in capacitance between the insulated wires forming the communication line is 25 pF/m or less.

This application is the U.S. National Phase of PCT/JP2018/003423 filed Feb. 1, 2018, which claims priority to JP 2017-017103 filed Feb. 1, 2017, the entire disclosure of which is incorporated herein by reference.

### BACKGROUND

The present disclosure relates to a communication cable, and more specifically to a communication cable that can be used for high-speed communication in automobiles or the like.

The demand for high-speed communication has been increasing in the automotive and other sectors. Transmission characteristics such as the characteristic impedance of a cable that is used for high-speed communication need to be strictly controlled. For example, the characteristic impedance of a cable that is used for Ethernet communication needs to be controlled to fall in a predetermined range such as 100±10Ω.

The characteristic impedance of a communication cable is determined by the specific configuration of the communication cable, such as the type, dimensions, shape, and the like of its conductor and insulating covering. For example, JP 2005-32583A discloses a shielded communication cable that includes a twisted wire pair obtained by twisting together a pair of insulated core wires each including a conductor and an insulator covering the conductor, a metal foil shield as a shield covering the twisted wire pair, an earth wire conductively connected to the metal foil shield, and a sheath covering the entirety of these. This shielded communication cable has a characteristic impedance of 100±10Ω. The conductor of each insulated core wire used in this cable has a diameter of 0.55 mm and the insulator covering the conductor has a thickness of 0.35 to 0.45 mm.

### SUMMARY

There is a strong demand for communication cables with smaller diameters in automobiles or the like. To satisfy this demand, it is necessary to reduce the diameter of the communication cable while achieving required transmission characteristics such as the characteristic impedance. As one way to reduce the diameter of a communication cable that includes a twisted wire pair, one might consider reducing the thickness of insulating coverings of insulated wires that constitute the twisted wire pair. However, the inventors of the present disclosure tested the communication cable described in JP 2005-32583A and found that if the thickness of the insulator was reduced to less than 0.35 mm, the characteristic impedance decreased to less than 90Ω, which is out of the range of 100±10Ω required for Ethernet communication.

disclosure An exemplary aspect of the disclosure provides a communication cable that has a reduced diameter while having a required characteristic impedance.

A communication cable according to the present disclosure includes a communication line that includes a pair of insulated wires that each include a conductor that has a cross-sectional area of less than 0.22 mm² and an insulating covering that covers an outer periphery of the conductor, wherein the communication cable has a characteristic impedance in a range of 100±10Ω, and a difference in capacitance between the insulated wires forming the communication line is 25 pF/m or less.

Preferably, the communication line is a twisted wire pair formed by the pair of insulated wires that are twisted together.

Preferably, the communication cable includes a sheath that is made of an insulating material and covers an outer periphery of the communication line, and there is a void between the sheath and the insulated wires forming the communication line. Preferably, in a cross section across an axis of the communication cable, the ratio of an area of the void to an area of a region surrounded by an outer peripheral edge of the sheath is 8% or more. Preferably, in a cross section across an axis of the communication cable, the ratio of an area of the void to an area of a region surrounded by an outer peripheral edge of the sheath is 30% or less.

Preferably, adhesive power of the sheath with respect to the insulated wires is 4 N or more. Preferably, the sheath has a dielectric loss tangent of 0.0001 or more. Preferably, the sheath has a dielectric loss tangent that is larger than a dielectric loss tangent of the insulating covering. Preferably, the insulating covering has a dielectric loss tangent of 0.001 or less.

Preferably, the conductor of each of the insulated wires has a tensile strength of 380 MPa or more. Preferably, the insulating covering of each of the insulated wires has a thickness of 0.30 mm or less. Preferably, each of the insulated wires has an outer diameter of 1.05 mm or less.

Preferably, the communication line is a twisted wire pair formed by the pair of insulated wires that are twisted together, and a twist pitch of the twisted wire pair is 45 times or less of an outer diameter of each of the insulated wires. Preferably, the conductor of each of the insulated wires has a breaking elongation of 7% or more. In this case, preferably, the communication line is a twisted wire pair formed by the pair of insulated wires that are twisted together, and a twist pitch of the twisted wire pair is 15 times or more of an outer diameter of each of the insulated wires. Alternatively, preferably, the communication line is a twisted wire pair formed by the pair of insulated wires that are twisted together, the conductor of each of the insulated wires has a breaking elongation of less than 7%, and a twist pitch of the twisted wire pair is 25 times or less of an outer diameter of each of the insulated wires.

Preferably, the conductor of each of the insulated wires is a twisted wire that includes a strand made of a first copper alloy that contains 0.05% by mass or more and 2.0% by mass or less of Fe, 0.02% by mass or more and 1.0% by mass or less of Ti, 0% by mass or more and 0.6% by mass or less of Mg, and the remaining portion consisting of Cu and inevitable impurities, or a strand made of a second copper alloy that contains 0.1% by mass or more and 0.8% by mass or less of Fe, 0.03% by mass or more and 0.3% by mass or less of P, 0.1% by mass or more and 0.4% by mass or less of Sn, and the remaining portion consisting of Cu and inevitable impurities. [0014] In the above-described communication cable according to the present disclosure, the conductor of each insulated wire forming the communication line has a small cross-sectional area of less than 0.22 mm². This is a small cross-sectional area for a conductor of an insulated wire that form a communication line of a communication cable, and enables reduction in the diameter of the conductor. Consequently, the distance between the two conductors forming the communication line decreases, and the characteristic impedance of the communication cable increases. As a result, even if the thickness of the insulating covering of the insulated wire is reduced to reduce the diameter of the communication cable, it is possible to keep the characteristic impedance from becoming lower than the range of 100±10Ω. Also, the small diameter of the conductor itself contributes to reduction in the diameter of the communication cable.

Further, if a difference in capacitance between the insulated wires forming the communication line is 25 pF/m or less, it is possible to suppress changes in the waveform of a signal transmitted through the communication cable and the influence of external noise. This contributes to improvement of transmission characteristics of the communication cable.

If the communication line is a twisted wire pair formed by the pair of insulated wires that are twisted together, the influence of external noise can be suppressed when a differential mode signal is transmitted through the communication line.

If the communication cable includes a sheath that is made of an insulating material and covers an outer periphery of the communication line and there is a void between the sheath and the insulated wires forming the communication line, there is a layer of air around the communication line, and therefore the characteristic impedance of the communication cable can be increased compared to a case where the sheath has a solid structure. Accordingly, even if the thickness of the insulating covering of the insulated wire is reduced, a value that is sufficiently high as the characteristic impedance of the communication cable can be easily maintained. A reduction in the thickness of the insulating covering of the insulated wire contributes to reduction in the outer diameter of the entire communication cable.

If, in a cross section across an axis of the communication cable, the ratio of an area of the void to an area of a region surrounded by an outer peripheral edge of the sheath is 8% or more, the characteristic impedance of the communication cable increases, and therefore this configuration is particularly effective to reduce the outer diameter of the communication cable.

If, in a cross section across an axis of the communication cable, the ratio of an area of the void to an area of a region surrounded by an outer peripheral edge of the sheath is 30% or less, it is possible to easily prevent variation and temporal change in various transmission characteristics such as the characteristic impedance of the communication cable, which would otherwise be caused when the void is too large and the position of the communication line changes in the interior space of the sheath.

If adhesive power of the sheath with respect to the insulated wires is 4 N or more, it is possible to easily prevent displacement of the communication line relative to the sheath and, if the communication line is a twisted wire pair, to prevent loosening of the twist structure of the twisted wire pair, and consequent variation and temporal change in various transmission characteristics such as the characteristic impedance of the communication cable.

If the sheath has a dielectric loss tangent of 0.0001 or more, coupling between a ground potential of the surrounding of the communication cable and the communication line can be effectively reduced by dielectric loss at the sheath as a result of the large dielectric loss tangent of the sheath. As a result, a high level of transmission mode conversion such as 46 dB or more can be achieved.

If the sheath has a dielectric loss tangent that is larger than a dielectric loss tangent of the insulating covering, it is easy to achieve both reduction of the coupling with the ground potential and suppression of signal attenuation in the communication cable.

If the insulating covering has a dielectric loss tangent of 0.001 or less, the influence of signal attenuation in the communication line can be suppressed.

If the conductor of the insulated wire has a tensile strength of 380 MPa or more, the diameter of the conductor can be easily reduced while strength required for a cable being maintained. As a result, the diameter of the communication cable can be easily reduced by reducing the thickness of the insulating covering.

If the thickness of the insulating covering of the insulated wire is 0.30 mm or less, the diameter of the insulated wire is sufficiently reduced, and consequently the diameter of the entire communication cable can be easily reduced.

The diameter of the entire communication cable can also be easily reduced if the insulated wire has an outer diameter of 1.05 mm or less.

If the communication line is a twisted wire pair formed by the pair of insulated wires that are twisted together, and a twist pitch of the twisted wire pair is 45 times or less of an outer diameter of each of the insulated wires, loosening of the twist structure of the twisted wire pair is unlikely to occur, and therefore it is possible to easily prevent variation and temporal change in various transmission characteristics such as the characteristic impedance of the communication cable, that would be caused by loosening of the twist structure.

If the conductor of the insulated wire has a breaking elongation of 7% or more, the conductor has high impact resistance and can withstand impact that may be applied to the conductor in a process of assembling a wire harness using the communication cable or a process of attaching the wire harness, for example.

In this case, if the communication line is a twisted wire pair formed by the pair of insulated wires that are twisted together, and a twist pitch of the twisted wire pair is 15 times or more of an outer diameter of each of the insulated wires, owing to a high breaking elongation of the insulated wires, the gap between the insulated wires can be kept small even though the twist pitch of the twisted wire pair is large, and consequently the characteristic impedance of the communication cable can be stably maintained and kept from becoming too high relative to a required range.

Alternatively, if the communication line is a twisted wire pair formed by the pair of insulated wires that are twisted together, the conductor of each of the insulated wires has a breaking elongation of less than 7%, and a twist pitch of the twisted wire pair is 25 times or less of an outer diameter of each of the insulated wires, the small twist pitch of the twisted wire pair compensates for the low breaking elongation of the conductor and the twist structure of the twisted wire pair can be stably maintained in a state where the gap between the insulated wires is small. Consequently, the characteristic impedance of the communication cable can be stably maintained and kept from becoming too high relative to a required range.

If the conductor of the insulated wire is a twisted wire that includes a strand made of a first copper alloy that contains 0.05% by mass or more and 2.0% by mass or less of Fe, 0.02% by mass or more and 1.0% by mass or less of Ti, 0% by mass or more and 0.6% by mass or less of Mg, and the remaining portion consisting of Cu and inevitable impurities, or a strand made of a second copper alloy that contains 0.1% by mass or more and 0.8% by mass or less of Fe, 0.03% by mass or more and 0.3% by mass or less of P, 0.1% by mass or more and 0.4% by mass or less of Sn, and the remaining portion consisting of Cu and inevitable impurities, the diameter of the conductor can be easily reduced while strength of the conductor being maintained because these alloys tend to show extremely high tensile strength. As a result, even if the thickness of the insulating covering of the insulated wire is reduced, it is possible to keep the characteristic impedance from becoming lower than the range of 100±10 Ω.

### BRIEF DESCRIPTION OF THE DRAWINGS

FIG. 1 is a cross-sectional view of a communication cable according to one embodiment of the present disclosure, provided with a sheath, which is a loose jacket.

FIG. 2 is a cross-sectional view of a communication cable provided with a sheath, which is a solid jacket.

FIG. 3 shows diagrams illustrating two twist structures of a twisted wire pair, in which FIG. 3(a) shows a first twist structure (without twirling) and FIG. 3(b) shows a second twist structure (with twirling). The dashed line in each diagram is a guide that indicates portions corresponding to the same position relative to the axis of an insulated wire, along the axis of the insulated wire.

FIG. 4 is a diagram showing the relationship between the thickness of an insulating covering of an insulated wire and the characteristic impedance for each of a case where the sheath is a loose jacket and a case where the sheath is a solid jacket. A simulation result of a case where the sheath is not provided is also shown.

### DETAILED DESCRIPTION OF EMBODIMENTS

The following describes a communication cable according to one embodiment of the present disclosure in detail with reference to the drawings. Note that various material properties that depend on measurement frequency and/or measurement environment, such as capacitance, dielectric constant, dielectric loss tangent, and the like, are defined with respect to a frequency of communication to which the communication cable is applied, which is in a frequency range of 1 to 50 MHz, for example, and are values measured at room temperature in the atmosphere, unless otherwise stated.

Configuration of Communication Cable

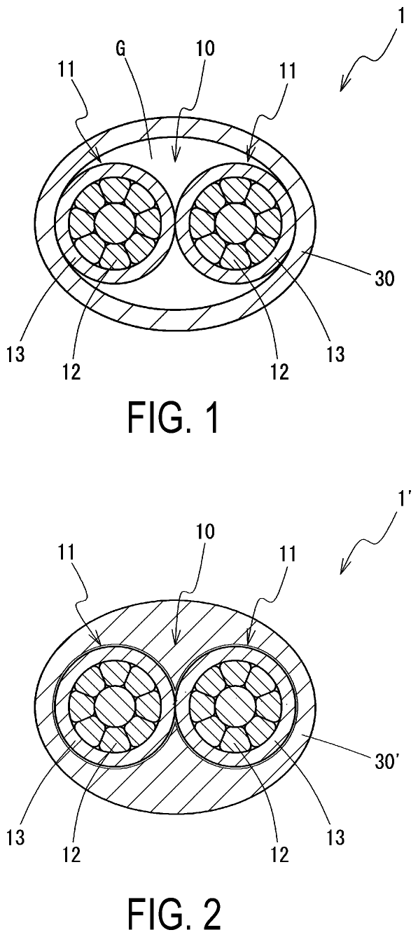

FIG. 1 is a cross-sectional view of a communication cable 1 according to one embodiment of the present disclosure.

The communication cable 1 includes, as a communication line, a twisted wire pair 10 that is obtained by twisting together a pair of insulated wires 11 and 11. Each insulated wire 11 includes a conductor 12 and an insulating covering 13 that covers an outer periphery of the conductor 12. The communication cable 1 further includes a sheath 30 that is made of an insulating material and covers an outer periphery of the entire twisted wire pair 10. The sheath 30 continuously surrounds the single twisted wire pair 10 all around its outer periphery about the center along the longitudinal axis. Note that the following describes a case where the communication line 10 is a twisted wire pair from the standpoint of achieving a noise reduction effect of the twist structure, but the communication line 10 is not limited to twisted wire pairs so long as it is constituted by a pair of insulated wires 11 and 11 and is capable of transmitting differential mode signals. For example, the communication line 10 may be constituted by two insulated wires 11 and 11 that extend side-by-side without being twisted together.

The communication cable 1 preferably has a characteristic impedance in a range of 100±10Ω. The characteristic impedance in the range of 100±10Ω is typically required for a cable for Ethernet communication. The communication cable 1 having such a characteristic impedance can be favorably used for high-speed communication in automobiles or the like.

The communication cable 1 can be favorably used for mainly transmitting signals in a frequency range of 1 to 100 MHz and exhibit excellent transmission characteristics. However, the communication cable 1 can also be used for transmitting signals in a GHz range, such as 1 GHz or higher.

### (1) Configuration of Insulated Wire

(1-1) Conductor

The conductor 12 of each insulated wire 11 constituting the twisted wire pair 10 preferably has a cross-sectional area of less than 0.22 mm², more preferably 0.15 mm² or less, and further preferably 0.13 mm² or less. The outer diameter of the conductor 12 is preferably 0.55 mm or less, more preferably 0.50 mm or less, and further preferably 0.45 mm or less. If the conductor 12 has such a small diameter, the distance between two conductors 12 and 12 (distance between centers of the conductors 12 and 12) constituting the twisted wire pair 10 decreases and the characteristic impedance of the communication cable 1 increases. That is, the characteristic impedance required for the communication cable 1 (for example, 100±10Ω) can be achieved by the effect of reducing the diameter of the conductor 12, even if the thickness of the insulating covering 13 covering the outer periphery of the conductor 12 is reduced.

Specifically, if the conductor 12 of the communication cable 1 has a small cross-sectional area of less than 0.22 mm², a characteristic impedance of 100±10Ω can be easily achieved even if the thickness of the insulating covering 13 covering the outer periphery of the conductor 12 is reduced to 0.30 mm or less, for example. Note that if the diameter of the conductor 12 is reduced too much, it is difficult to maintain strength and the characteristic impedance of the communication cable 1 becomes too large. Therefore, the cross-sectional area of the conductor 12 is preferably 0.08 mm² or more.

The conductor 12 of each insulated wire 11 constituting the twisted wire pair 10 is preferably constituted by a metal wire that has a tensile strength of 380 MPa or more. If the conductor 12 has a high tensile strength, the tensile strength required for a cable can be maintained even if the diameter of the conductor 12 is reduced. That is, the higher the tensile strength of the conductor 12 is, the easier it is to reduce the diameter of the conductor 12. As described above, when the diameter of the conductor 12 is reduced, the characteristic impedance required for the communication cable 1 (for example, 100±10Ω) can be achieved by the effect of reducing the diameter of the conductor 12 even if the thickness of the insulating covering 13 covering the outer periphery of the conductor 12 is reduced.

When a conductor 12 that has a tensile strength of at least 380 MPa is used, the diameter of the conductor 12 can be easily reduced to such an extent that the cross-sectional area of the conductor becomes less than 0.22 mm². As a result, compared to using a conductor that has a low tensile strength and may be difficult to reduce in diameter, an equivalent or higher characteristic impedance can be easily achieved even if the thickness of the insulating covering 13 is reduced.

Specific examples of metal wires that can give a tensile strength of 380 MPa or more include a first copper alloy wire containing Fe and Ti and a second copper alloy wire containing Fe, P, and Sn described below. The tensile strength of the conductor 12 is more preferably 400 MPa or more, yet more preferably 440 MPa or more, and further preferably 480 MPa or more.

The conductor 12 preferably has a breaking elongation of at least 7%, and more preferably at least 10%. A conductor that has a high tensile strength typically has low toughness and often shows low impact resistance when a force is suddenly applied. However, if the conductor 12 has a high tensile strength such as 380 MPa or more, or 400 MPa or more as described above and has a breaking elongation of 7% or more, then the conductor 12 can exhibit high impact resistance even if an impact is applied to the conductor 12 in a process of assembling a wire harness using the communication cable 1 or a process of attaching the wire harness.

Further, if the conductor 12 has a high breaking elongation such as 7% or more, the insulated wire 11 is soft, and therefore when two insulated wires 11 are twisted together to form the twisted wire pair 10, a gap is unlikely to be formed between the two insulated wires 11. Further, the twist structure of the twisted wire pair 10 is stably maintained. Although the characteristic impedance of the communication cable 1 tends to increase as the gap between the two insulated wires 11 becomes large, if the twist structure is stably maintained in a state where the gap is small, the characteristic impedance can be kept from becoming too high and it is easy to stably maintain the characteristic impedance in a required range while suppressing variation.

As the resistance of the conductor 12 decreases, the conductivity required for signal transmission can be achieved with a smaller diameter of the conductor 12, so that the diameter and weight of the conductor 12 can be easily reduced. For this reason, the resistance of the conductor is set to 210 mΩ/m or less, for example. On the other hand, mode conversion characteristics of the communication cable 1 improve as the resistance of the conductor increases. For this reason, the resistance of the conductor is set to 150 mΩ/m or more, for example.

The conductor 12 of the insulated wire 11 may be constituted by any metal wire, but preferably includes a copper wire or a copper alloy wire. Various soft copper wires or hard copper wires can be used as copper alloy wires. Examples of soft copper wires include a copper alloy wire containing Fe and Ti (hereinafter referred to as a first copper alloy wire) and a copper alloy wire containing Fe, P, and Sn (hereinafter referred to as a second copper alloy wire) described below. Examples of hard copper wires include a known Cu—Sn alloy wire containing 0.1 to 1.7% by mass of Sn.

The first copper alloy wire has the following component composition.

Fe: 0.05% by mass or more and 2.0% by mass or less

Ti: 0.02% by mass or more and 1.0% by mass or less

Mg: 0% by mass or more and 0.6% by mass or less (this including compositions not containing Mg)

The remaining portion is Cu and inevitable impurities.

The first copper alloy wire having the above-described composition has an extremely high tensile strength. A particularly high tensile strength can be achieved if the amount of Fe is 0.8% by mass or more and if the amount of Ti is 0.2% by mass or more. The tensile strength can be increased by increasing the wiredrawing degree to reduce the diameter of the wire or performing thermal treatment after wiredrawing. For example, it is possible to obtain a conductor 12 that has a high tensile strength such as 380 MPa or more, or 400 MPa or more.

The second copper alloy wire has the following component composition.

Fe: 0.1% by mass or more and 0.8% by mass or less

P: 0.03% by mass or more and 0.3% by mass or less

Sn: 0.1% by mass or more and 0.4% by mass or less

The remaining portion is Cu and inevitable impurities.

The second copper alloy wire having the above-described composition has an extremely high tensile strength. A particularly high tensile strength can be achieved if the amount of Fe is 0.4% by mass or more and if the amount of P is 0.1% by mass or more. The tensile strength can be increased by increasing the wiredrawing degree to reduce the diameter of the wire or performing thermal treatment after wiredrawing. For example, it is possible to obtain a conductor 12 that has a high tensile strength such as 380 MPa or more, or 400 MPa or more.

The tensile strength and breaking elongation can be adjusted by performing thermal treatment on a copper alloy wire. For example, it is possible to achieve a high breaking elongation such as 7% or more by performing thermal treatment on soft copper wires such as the above-described first and second copper alloy wires. Generally, when a copper alloy is subjected to thermal treatment at a higher temperature, the breaking elongation tends to be improved, but the tensile strength tends to decrease. However, when the above-described first and second copper alloy wires are subjected to thermal treatment, the copper alloy wires can have both a breaking elongation of 7% or more and a tensile strength of 380 MPa or more.

The conductor 12 may be constituted by a single strand, but is preferably constituted by a twisted wire that is obtained by twisting together a plurality of (for example, seven) strands from the standpoint of improving bendability, for example. In this case, the strands may be subjected to compression molding after being twisted together to obtain a compressed twisted wire. The outer diameter of the conductor 12 can be reduced by compression molding. Also, the surface area of the outer periphery of the conductor 12 can be increased by compression molding, and as a result, attenuation of a signal transmitted through the conductor 12 can be suppressed by the influence of the skin effect.

If the conductor 12 is constituted by a twisted wire, the conductor may be constituted by a single type of strands or two or more types of strands. In an example where two or more types of strands are used, the strands include strands made of copper alloys, which are soft copper wires such as the first and second copper alloy wires or hard copper wires such as Cu—Sn alloy wires, and strands made of a metal material other than copper alloys, such as SUS. Also, a single type of strands or a combination of two or more types of strands may be used as copper alloy wires.

### (1-2) Insulating Covering

The insulating covering 13 of the insulated wire 11 may be made of any insulating polymer material. The insulating covering 13 preferably has a relative dielectric constant of 4.0 or less from the standpoint of achieving a predetermined high characteristic impedance. Examples of polymer materials satisfying the above include polyolefins such as polyethylene and polypropylene, polyvinyl chloride, polystyrene, polytetrafluoroethylene, and polyphenylene sulfide. Further, the insulating covering 13 may contain an additive such as a flame retardant in addition to the polymer material, as appropriate.

A polymer material that has low molecular polarity is preferably used as the polymer material of the insulating covering 13 from the standpoint of reducing the dielectric constant of the insulating covering 13, and particularly, preventing an excessive increase in the dielectric constant even under a high temperature in an in-vehicle environment or the like. Out of the above-listed examples, polyolefins, which are nonpolar polymer materials, are preferably used, for example.

The insulating covering 13 preferably has a small dielectric loss tangent from the standpoint of suppressing the influence of signal attenuation in the twisted wire pair 10 and reducing the diameter and weight of the insulated wire 11. The dielectric loss tangent is preferably 0.001 or less, and more preferably 0.0006 or less, for example. Further, the dielectric loss tangent of the material of the insulating covering 13 is preferably equal to or less than the dielectric loss tangent of the material of the sheath 30, and more preferably less than the dielectric loss tangent of the material of the sheath 30, as described later in detail.

The polymer material of the insulating covering 13 may be foamed or not foamed. The polymer material is preferably foamed from the standpoints of reducing the dielectric constant of the insulating covering 13 to reduce the diameter of the insulated wire 11 and reducing the weight of the insulating covering 13, and the polymer material is preferably not foamed from the standpoints of stabilizing the transmission characteristics of the communication cable 1 and simplifying the production process of the insulating covering 13. If the insulating covering 13 is foamed, the degree of foaming is preferably 15 to 85%. Further, the polymer material of the insulating covering 13 may be crosslinked or not crosslinked. The heat-resistance of the insulating covering 13 can be particularly improved through crosslinking.

The insulating covering 13 may include a plurality of layers, but is preferably constituted by a single layer from the standpoint of simplifying the configuration. If the insulating covering 13 is constituted by a single layer, the single layer preferably has the above-described properties. On the other hand, if the insulating covering 13 includes a plurality of layers, each layer preferably has the above-described properties.

In the communication cable 1, the thickness of the insulating covering 13 that is necessary to achieve a predetermined characteristic impedance can be reduced as a result of the characteristic impedance being increased by the reduction in the diameter of the conductor 12 and the consequent decrease of the distance between the conductors 12 and 12. The thickness of the insulating covering 13 is preferably 0.30 mm or less, more preferably 0.25 mm or less, and further preferably 0.20 mm or less, for example. Note that the thickness of the insulating covering 13 is preferably 0.15 mm or more because it is difficult to achieve the required characteristic impedance if the insulating covering 13 is extremely thin.

As a result of the reduction in the diameter of the conductor 12 and the reduction in the thickness of the insulating covering 13, the diameter of the entire insulated wire 11 is reduced. The outer diameter of the insulated wire 11 can be reduced to 1.05 mm or less, 0.95 mm or less, or 0.85 mm or less, for example. The diameter of the entire communication cable 1 can be reduced by reducing the diameter of the insulated wire 11.

In the insulated wire 11, the insulating covering 13 is preferably highly uniform in thickness (insulation thickness) over the perimeter of the conductor 12. That is, the insulating covering preferably has small variation in thickness. In this case, eccentricity of the conductor 12 decreases, and symmetry of the positions of the conductors 12 in the twisted wire pair 10 is improved. As a result, the transmission characteristics of the communication cable 1, particularly, the mode conversion characteristics can be improved. Each insulated wire 11 preferably has an eccentricity ratio of 65% or more, and more preferably 75% or more, for example. The eccentricity ratio is calculated using the following expression: [minimum insulation thickness]/[maximum insulation thickness]×100%.

The insulated wire 11 preferably has an uneven surface with a low degree of smoothness. In this case, sliding and consequent displacement are unlikely to occur between the two insulated wires 11 of the twisted wire pair 10, and the twist structure of the twisted wire pair 10 can be easily maintained. As a result, even when the communication cable 1 is subjected to vibrations or the like, the twist structure of the twisted wire pair 10 is hardly affected and the transmission characteristics can be stably maintained. For example, the kinetic friction coefficient measured by rubbing insulating materials of the insulating coverings 13 against each other is preferably 0.1 or more. The friction coefficient can be increased by, for example, adjusting the extrusion temperature of the insulating covering 13 to form an uneven surface of the insulating covering 13.

### (2) Configuration of Twisted Wire Pair

### (2-1) Capacitance

In the present embodiment, a difference in capacitance (electrostatic capacity) between the insulated wires 11 constituting the twisted wire pair 10 is 25 pF/m or less. The difference in capacitance is more preferably 15 pF/m or less. The capacitance of each insulated wire 11 is measured with respect to a ground potential corresponding to an environment in which the twisted wire pair 10 is used.

The smaller the difference in capacitance between the insulated wires 11 is, the more changes in the waveform of a signal transmitted through the twisted wire pair 10 can be suppressed. Further, the influence of external noise on the signal transmitted through the twisted wire pair 10 can be suppressed. As a result, a mode conversion characteristic of the communication cable 1 can be improved. Here, the mode conversion characteristic means a transmission mode conversion characteristic (LCTL) or a reflection mode conversion characteristic (LCL), and particularly the transmission mode conversion characteristic. If the difference in capacitance between the insulated wires 11 is 25 pF/m or less, a communication cable 1 having excellent mode conversion characteristics, such as LCTL≥46.0 dB (50 MHz) and LCL≥46.0 dB (50 MHz) can be easily obtained. If the difference in capacitance is 15 pF/m or less, mode conversion characteristics can be further improved.

The capacitance of the insulated wire 11 increases with a decrease in the thickness of the insulating covering 13. However, if the difference in capacitance between the insulated wires 11 is reduced to the above-described level or lower, the communication cable 1 can transmit a signal in a state where changes in the waveform and the influence of noise are sufficiently small in automobiles or the like.

The variation of the capacitance of the insulated wire 11 between respective portions of the communication cable 1 in its axial direction is preferably 12% or less, and more preferably 7% or less. This is because transmission characteristics of the communication cable 1 tend to be unstable if the capacitance varies in the axial direction.

### (2-2) Twist Structure of Twisted Wire Pair

The twisted wire pair 10 can be obtained by twisting together two insulated wires 11, and the twist pitch can be set according to the outer diameter of each insulated wire 11, for example. Loosening of the twist structure can be effectively suppressed by setting the twist pitch at 60 times or less of the outer diameter of the insulated wire 11, more preferably 45 times or less, and further preferably 30 times or less. Loosening of the twist structure may cause variation or temporal change in various transmission characteristics such as the characteristic impedance of the communication cable 1. Particularly, if a loose jacket-type sheath 30 is used as described later, there is a void G between the sheath 30 and the twisted wire pair 10, and accordingly if a force that causes loosening of the twist structure acts on the twisted wire pair 10, it may be difficult to suppress loosening of the twist structure with the sheath 30, compared to a case where a solid jacket-type sheath is used. However, if the above-described twist pitch is selected, loosening of the twist structure can be effectively suppressed even if the loose jacket-type sheath 30 is used. If loosening of the twist structure is suppressed, the distance (inter-wire distance) between the two insulated wires 11 constituting the twisted wire pair 10 can be maintained at a small value, for example, substantially 0 mm, at each position within a pitch, and stable transmission characteristics can be achieved. The inter-wire distance is preferably 20% or less of the outer diameter of the insulated wire 11.

On the other hand, an excessively small twist pitch of the twisted wire pair 10 reduces productivity of the twisted wire pair 10 and increases the production cost, and therefore the twist pitch is preferably 8 times or more of the outer diameter of the insulated wire 11, more preferably 12 times or more, and further preferably 15 times or more. For example, if the conductor 12 has a breaking elongation of 7% or more, the gap between the insulated wires 11 can be kept small and the characteristic impedance of the communication cable 1 can be stably maintained and kept from becoming too high relative to a required range, such as 100±10Ω, even if the twisted wire pair 10 has a large twist pitch such as 15 times or more of the outer diameter of the insulated wire 11.

Conversely, if the conductor 12 of the insulated wire 11 has a low breaking elongation, it is possible to compensate for the low breaking elongation by reducing the twist pitch of the twisted wire pair 10 to stably maintain the twist structure of the twisted wire pair 10 in a state where the gap between the insulated wires 11 is small. For example, even if the breaking elongation of the conductor 12 is less than 7%, the characteristic impedance of the communication cable 1 can be stably maintained and kept from becoming too high relative to a required range, such as 100±10Ω, by reducing the twist pitch of the twisted wire pair to 25 times or less of the outer diameter of the insulated wire 11, or further to 20 times or less, or 15 times or less.

Note that the above-described inter-wire distance is defined as the size of the gap between the two insulated wires 11, and a state where the inter-wire distance is 20% or less of the outer diameter of the insulated wire 11 roughly corresponds to a state where the distance between the centers of the two insulated wires 11 is 120% or less of the outer diameter of the insulated wire 11. If the outer diameter of the insulated wire 11 is 1.05 mm or less as described above, a state where the distance between the centers of the insulated wires 11 is about 1.26 mm or less is preferable. By reducing the distance between the centers of the insulated wires 11 to 1.26 mm or less, for example, stable transmission characteristics can be achieved and the diameter of the entire communication cable 1 can be reduced.

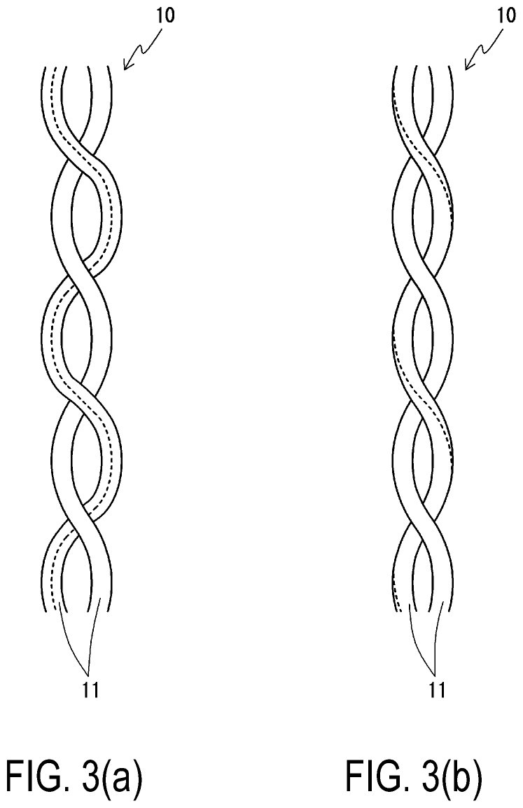

Examples of the twist structure of the two insulated wires 11 of the twisted wire pair 10 include the following two structures. As illustrated in FIG. 3(a), in a first twist structure, twirling about the twist axis is not added to the insulated wires 11, and directions of respective portions of the insulated wire 11 relative to its axis do not change along the twist axis. That is, portions corresponding to the same position relative to the axis of the insulated wire 11 always face the same direction, for example, upward, over the entire region of the twist structure. In the drawing, the portions corresponding to the same position relative to the axis of the insulated wire 11 are shown with a dashed line along the axis of the insulated wire 11, and this dashed line always appears at the center of the frontside of the insulated wire 11 on the sheet, because no twirling is added. Note that the twist structure of the twisted wire pair 10 is illustrated in a loosened state in each of FIGS. 3(a) and 3(b) so that it can be easily understood.

On the other hand, as illustrated in FIG. 3(b), in a second twist structure, twirling about the twist axis is added to the insulated wires 11, and directions of respective portions of the insulated wire 11 relative to its axis change along the twist axis. That is, portions corresponding to the same position relative to the axis of the insulated wire 11 face different directions in the twist structure. In the drawing, the portions corresponding to the same position relative to the axis of the insulated wire 11 are shown with a dashed line along the axis of the insulated wire 11, and this dashed line appears on the frontside of the sheet in only part of one pitch of the twist structure and the position of this dashed line continuously changes between the frontside and the backside of the sheet in one pitch of the twist structure, because twirling is added.

Out of the above-described two twist structures, the first twist structure is preferably employed. This is because the first twist structure has a smaller change in the inter-wire distance between the two insulated wires 11 in one pitch of the twist structure. Particularly, in the communication cable 1 of the present embodiment, the diameter of the insulated wire 11 is reduced, so that the inter-wire distance is likely to change by the influence of the twirling. However, such an influence can be suppressed by employing the first twist structure. If the inter-wire distance changes, various parameters such as capacitance vary between respective portions of the communication cable 1 in the axial direction, and therefore the transmission characteristics of the communication cable 1 tend to be unstable. As described above, the inter-wire distance between the insulated wires 11 is preferably 20% or less of the outer diameter of the insulated wire 11.

If the conductors 12 of the insulated wires 11 are each constituted by a plurality of strands that are twisted together, the twist direction of the two insulated wires 11 of the twisted wire pair 10 may be the same as or opposite to the twist direction of the strands constituting the conductors 12 of the insulated wires 11. However, if the twist direction of the two insulated wires 11 of the twisted wire pair 10 is the same as the twist direction of the strands constituting the conductors 12 of the insulated wires 11, the strands constituting the conductors 12 are unlikely to be untwisted even when they are flexed, for example, and the flex resistance of the entire twisted wire pair 10 can be improved.

The difference in length (wire length difference) between the two insulated wires 11 constituting the twisted wire pair 10 is preferably small. If the difference is small, symmetry of the two insulated wires 11 can be improved in the twisted wire pair 10, and transmission characteristics, particularly mode conversion characteristics can be improved. For example, if the wire length difference per 1 m of the twisted wire pair is 5 mm or less, and more preferably 3 mm or less, it is easy to suppress the influence of the wire length difference.

The two insulated wires 11 of the twisted wire pair 10 may be merely twisted together or the insulating coverings 13 of the respective insulated wires 11 may be fused or bonded together in the entire region or a part of the region in the longitudinal direction. The balance between the two insulated wires 11 can be stabilized through fusing or bonding to improve transmission characteristics of the communication cable 1.

(3) General Configuration of Sheath

In the present embodiment, the sheath 30 is not necessarily provided, but if the sheath 30 is provided, it is used to protect the twisted wire pair 10 and maintain the twist structure, for example. Particularly in cases where the communication cable 1 is used in an automobile, the communication cable 1 needs to be protected from the influence of moisture, and the sheath 30 serves to prevent various characteristics such as the characteristic impedance of the communication cable 1 from being affected by contact with moisture.

In the embodiment of FIG. 1, the sheath 30 is formed as a loose jacket and has a tube-like shape accommodating the twisted wire pair 10 inside it. The inner peripheral surface of the sheath 30 is in contact with the insulated wires 11 constituting the twisted wire pair 10 in only some regions in the circumferential direction, and in the other regions, there is a void G forming a layer of air between the sheath 30 and the insulated wires 11. Details of the configuration of the sheath 30 will be described later.

Note that in evaluations of the state of a cross section of the communication cable 1, such as the presence or absence of a void G between the sheath 30 and the insulated wires 11 and a ratio of the void G, which will be described later, it is preferable to cut the communication cable 1 after embedding the entire communication cable 1 in resin such as an acrylic resin and fixing the communication cable 1 in a state where the resin has permeated through the interior space of the sheath 30, so that the accuracy of the evaluations is not impaired as a result of the sheath 30 and the twisted wire pair 10 being deformed when the cross section is formed by cutting. The region of the cross section where the acrylic resin is present is the region that was previously occupied by the void G.

Unlike the communication cable disclosed in JP 2005-32583A, the communication cable 1 of the present embodiment does not include a shield that is made of a conductive material and surrounds the twisted wire pair 10 inside the sheath 30, and the sheath 30 directly surrounds the outer periphery of the twisted wire pair 10. Although the shield serves to shield the twisted wire pair 10 from noise that would otherwise enter from the outside or would otherwise be emitted to the outside, the communication cable 1 of the present embodiment is intended to be used under conditions where the influence of noise is not serious, and therefore the shield is not provided. From the standpoint of effectively reducing the diameter and cost by simplifying the configuration, it is preferable that not only the shield but also no other member is disposed between the sheath 30 and the twisted wire pair 10 of the communication cable 1 of the present embodiment and the sheath 30 directly covers the outer periphery of the twisted wire pair 10 with the void G interposed therebetween.

However, if it is desired to particularly reduce the influence of noise, the communication cable 1 may be provided with a shield made of a conductive material surrounding the twisted wire pair 10 inside the sheath 30. Note that if a shield is provided, the presence or absence of a void G between the sheath 30 and the twisted wire pair 10, the size of the void G, a degree of adhesion of the sheath 30 with respect to the insulated wires 11, and the like cannot be discussed, so that a description thereof given below does not apply to such a case.

(4) Characteristics of Entire Communication Cable

As described above, in the communication cable 1 of the present embodiment, the conductor 12 of the insulated wires 11 constituting the twisted wire pair 10 has a small cross-sectional area. As a result of reducing the diameter of the conductors 12, the distance between the two conductors 12 and 12 constituting the twisted wire pair 10 decreases. As a result of decreasing the distance between the two conductors 12 and 12, the characteristic impedance of the communication cable 1 increases. Although the characteristic impedance decreases with a decrease in the thickness of the insulating covering 13 of the insulated wire 11 constituting the twisted wire pair 10, the required characteristic impedance can be easily achieved in the communication cable 1 of the present embodiment by the effect of the decrease of the distance between the conductors 12 and 12 as the diameter of the conductors is reduced, even if the thickness of the insulating covering 13 is reduced. For example, if the conductor 12 has a small cross-sectional area such as less than 0.22 mm², the communication cable 1 can easily achieve a characteristic impedance of 100±10Ω even if the thickness of the insulating covering 13 is reduced to 0.30 mm or less. The cross-sectional area of the conductor 12 can be easily reduced when a wire having a high tensile strength is used as the conductor, for example.

The diameter (finished diameter) of the communication cable 1 as a whole can be reduced by reducing the thickness of the insulating covering 13 of the insulated wire 11. The diameter of the communication cable 1 can be reduced to 2.9 mm or less, 2.7 mm or less, or 2.5 mm or less, for example. If the diameter of the communication cable 1 is reduced while a predetermined characteristic impedance being maintained, the communication cable 1 can be favorably used for high-speed communication within a limited space, such as within an automobile.

Reduction in the diameter of the conductor 12 and reduction in the thickness of the insulating covering 13 constituting the insulated wire 11 are effective not only for reduction in the diameter of the communication cable 1 but also for reduction in the weight of the communication cable 1. If the weight of the communication cable 1 is reduced, the weight of the entire vehicle can be reduced when the communication cable 1 is used for communication in an automobile, for example, leading to reduction in fuel consumption of the vehicle.

Further, if the conductor 12 constituting the insulated wire 11 has a high tensile strength, the communication cable 1 has a high breaking strength. The breaking strength is preferably 100 N or more, and more preferably 140 N or more, for example. If the communication cable 1 has a high breaking strength, the communication cable can show a high holding force with respect to a terminal or the like at its end. That is, breaking of the communication cable 1 can be easily prevented in a portion where the terminal or the like is attached to the end. A high breaking strength such as 100 N or more, or 140 N or more can be easily achieved if the conductor 12 has a tensile strength of 380 MPa or more, or 400 MPa or more.

It is desirable that a communication cable satisfies predetermined levels of transmission characteristics other than the characteristic impedance, such as transmission loss (IL), reflection loss (RL), transmission mode conversion (LCTL), and reflection mode conversion (LCL), in addition to a sufficiently high characteristic impedance such as 100±10Ω. The communication cable 1 of the present embodiment that includes the loose jacket-type sheath 30 can easily satisfy the following levels of characteristics IL 0.68 dB/m (66 MHz), RL 20.0 dB (20 MHz), LCTL 46.0 dB (50 MHz), and LCL 46.0 dB (50 MHz), even if the thickness of the insulating covering 13 of the insulated wire 11 is reduced to less than 0.25 mm, or 0.15 mm or less.

Although the tensile strength of the conductor 12 can contribute to electrical characteristics such as the characteristic impedance of the communication cable 1, through reduction in the diameter of the conductor 12 as described above, the tensile strength of the conductor 12 itself has substantially no influence on the electrical characteristics of the communication cable 1 if the communication cable 1 can be obtained by using the conductor 12 having a predetermined diameter. For example, the characteristic impedance and mode conversion characteristics of the communication cable 1 do not depend on the tensile strength of the conductor 12 as shown in the Examples (experiment [11]) described later.

Further, even when a physical load is applied from the outside, the communication cable 1 of the present embodiment can easily maintain transmission characteristics at high levels by the effect of the high tensile strength of the conductor, for example. Examples of such a physical load include a lateral pressure.

### Detailed Configuration of Sheath

### (1) Constituent Materials of Sheath

The sheath 30 is made of a polymer material as a main component. The polymer material of the sheath 30 may be any polymer material. Specific examples of polymer materials include polyolefins such as polyethylene and polypropylene, polyvinyl chloride, polystyrene, polytetrafluoroethylene, and polyphenylene sulfide. Further, the sheath 30 may contain an additive such as a flame retardant in addition to the polymer material, as appropriate.

The sheath 30 is preferably made of an insulating material that has a dielectric loss tangent of 0.0001 or more. Dielectric loss at the sheath 30 increases with an increase in the dielectric loss tangent of the material of the sheath 30, and therefore common mode noise caused by coupling between the twisted wire pair 10 and a ground potential outside the communication cable 1 can be attenuated. As a result, a mode conversion characteristic of the communication cable 1 can be improved. As described above, the mode conversion characteristic is a transmission mode conversion characteristic (LCTL) or a reflection mode conversion characteristic (LCL), and particularly is the transmission mode conversion characteristic. A mode conversion characteristic is an index that indicates a degree of conversion between a differential mode and a common mode of signals transmitted through the communication cable 1. The larger the value (absolute value) of the mode conversion characteristic is, the more unlikely conversion between the modes occurs.

If the sheath 30 has a dielectric loss tangent of 0.0001 or more, a communication cable 1 having excellent mode conversion characteristics, such as LCTL≥46.0 dB (50 MHz) and LCL≥46.0 dB (50 MHz) can be easily obtained. If the dielectric loss tangent is 0.0006 or more, or 0.001 or more, mode conversion characteristics can be further improved. If the communication cable 1 is used in an automobile, for example, a member that serves as the ground potential such as a vehicle body is often disposed in the vicinity of the communication cable 1, so that it is effective to increase the dielectric loss tangent of the sheath 30 to reduce noise.

On the other hand, an excessively large dielectric loss tangent of the material of the sheath 30 increases attenuation of a differential mode signal transmitted through the twisted wire pair 10, which may result in communication failure. The influence of signal attenuation can be suppressed if the dielectric loss tangent of the sheath 30 is 0.08 or less, 0.01 or less, or 0.001 or less, for example.

The dielectric loss tangent of the sheath 30 can be adjusted by changing the polymer material and an additive such as a flame retardant constituting the sheath 30 and the amount of the additive, for example. For example, the dielectric loss tangent of the sheath 30 can be increased by using a polymer material that has a high molecular polarity. This is because a polymer material that has a high molecular polarity and a high dielectric constant typically has a large dielectric loss tangent. The dielectric loss tangent of the sheath 30 can also be increased by adding an additive that has a high polarity. The dielectric loss tangent can be further increased by increasing the amount of such an additive.

Incidentally, if the diameter of the entire communication cable 1 as described above is reduced by reducing the diameter of the insulated wire 11 and the thickness of the sheath 30, it is sometimes difficult to achieve a required characteristic impedance such as 100±10Ω. Accordingly, it can be considered to increase the characteristic impedance by reducing an effective dielectric constant of the communication cable 1 defined by the following formula (1). From this standpoint, it is preferable to use a polymer material that has a low molecular polarity and gives a low dielectric constant as the polymer material of the sheath 30.

$${Z}_{0} = \frac{{η}_{0}}{π \sqrt{{ɛ}_{eff}}} {cosh}^{- 1} ( \frac{D}{d} ) \qquad ( 1 )$$

Here, ε_{eff} represents the effective dielectric constant, d represents the diameter of the conductor, D represents the outer diameter of the cable, and no represents a constant.

Further, the communication cable 1 may be exposed to high temperatures in an in-vehicle environment or the like, and therefore a polymer material having a lower molecular polarity is also preferable as the polymer material of the sheath 30 from the standpoint of preventing a situation in which the characteristic impedance of the communication cable 1 decreases due to the dielectric constant of the sheath 30 largely increasing at high temperatures. Particularly, a nonpolar polymer material is preferably used as a polymer material having a low molecular polarity. Out of the above-listed various polymer materials, polyolefins are nonpolar polymer materials.

As described above, it is desirable that the sheath 30 has a large dielectric loss tangent, which is a parameter that tends to increase as the molecular polarity of the polymer material increases, whereas it is desirable that the polymer material of the sheath 30 has a low molecular polarity from a different standpoint. Therefore, the dielectric loss tangent of constituent materials of the sheath 30 as a whole can be increased by adding an additive that has a polarity that increases the dielectric loss tangent to a polymer material that does not have molecular polarity, such as polyolefins, or has a low molecular polarity.

Further, the dielectric loss tangent of the material of the sheath 30 is preferably equal to or more than the dielectric loss tangent of the material of the insulating covering 13 of the insulated wire 11, and more preferably more than the dielectric loss tangent of the insulating covering 13. This is because it is preferable that the sheath 30 has a large dielectric loss tangent from the standpoint of improving mode conversion characteristics as described above, whereas it is preferable that the insulating covering 13 has a small dielectric loss tangent from the standpoint of suppressing attenuation of a differential mode signal transmitted through the twisted wire pair 10, for example. The dielectric loss tangent of the sheath 30 is preferably 1.5 times or more of the dielectric loss tangent of the insulating covering 13, more preferably 2 times or more, and further preferably 5 times or more, for example. The relative dielectric constant of the sheath 30 is preferably 6.0 or less.

The polymer material of the sheath 30 may be foamed or not foamed. The polymer material is preferably foamed from the standpoint of, by the effect of air being held in foamed portions, reducing the dielectric constant of the sheath 30 to increase the characteristic impedance of the communication cable 1 and reducing the weight of the sheath 30, for example. The degree of foaming is preferably 20% or more. On the other hand, the polymer material is preferably not foamed from the standpoint of stabilizing transmission characteristics of the communication cable 1 by preventing variation in the transmission characteristics, which may be caused by variation in the degree of foaming. If the polymer material is foamed, the degree of foaming is preferably 85% or less. In terms of productivity of the sheath 30, it is more convenient not to foam the sheath 30 because a foaming process can be omitted, but it is more convenient to foam the sheath 30 from the standpoint that the dielectric constant of the sheath 30 can be reduced with no void G being provided (that is, a configuration corresponding to a solid jacket described later being employed) or the size of a void G being reduced. The polymer material of the sheath 30 may be crosslinked or not crosslinked. The heat-resistance of the sheath 30 can be particularly improved through crosslinking.

The polymer material of the sheath 30 may be the same type as or a different type from the polymer material of the insulating covering 13. The same type of material is preferably used from the standpoint of simplifying the configuration of the entire communication cable 1 and the production process, and a different type of material is preferably used from the standpoint of selecting physical properties such as the dielectric constant and dielectric loss tangent for each of the sheath 30 and the insulating covering 13 with high freedom.

The sheath 30 is preferably made of a material that has a small shrinkage ratio when it undergoes an environmental change caused by heating or the like or it is used over years. This is because the use of such a material can suppress a change in transmission characteristics of the communication cable 1 caused by a change in physical properties of the sheath 30 or a change in the position and holding state of the twisted wire pair 10 in the interior space of the sheath 30, which would be caused by shrinkage of the sheath 30. The shrinkage ratio of the sheath 30 when it is left to stand in an environment at 150° C. for three hours is preferably 3% or less, for example. Here, the shrinkage ratio of the sheath 30 can be defined as a reduction ratio of a surface area of the material. Further, the material of the sheath 30 preferably has water repellency from the standpoint of effectively suppressing the influence of contact with moisture on various characteristics of the communication cable 1.

### (2) Shape of Sheath

In the present embodiment, the sheath 30 is provided as a loose jacket and there is a void G between the sheath 30 and the insulated wires 11 constituting the twisted wire pair 10, as described above. However, the shape of the sheath 30 is not particularly limited, and it is not essential to provide the sheath 30 as a loose jacket and to provide a void G. That is, a communication cable 1′ that includes a sheath 30′ provided as a solid jacket as illustrated in FIG. 2 may also be employed. In this case, the sheath 30′ has a solid structure and is in contact with or located at a position very close to the insulated wires 11 constituting the twisted wire pair 10, and there is substantially no void between the sheath 30′ and the insulated wires 11 other than a void that is inevitably formed during production.

The configuration of a loose jacket is preferable for the sheath 30 than the configuration of a solid jacket from the standpoint of reducing the diameter of the communication cable 1 while maintaining the characteristic impedance at a predetermined high level. The characteristic impedance of the communication cable 1 increases if the twisted wire pair 10 is surrounded by a material having a low dielectric constant (see formula (1)), and accordingly the characteristic impedance can be increased with the configuration of a loose jacket including a layer of air around the twisted wire pair 10 compared to the configuration of a solid jacket in which a dielectric is located directly adjacent to the outer side of the twisted wire pair 10. Therefore, the configuration of a loose jacket is advantageous in that a required characteristic impedance such as 100±10Ω can be achieved even when the thickness of the insulating covering 13 of the insulated wires 11 is reduced. By reducing the thickness of the insulating covering 13, the diameter of the insulated wire 11 can be reduced, and consequently the outer diameter of the entire communication cable 1 can be reduced.

In an example, if the conductor 12 of the insulated wire 11 has a cross-sectional area of less than 0.22 mm² as described above and a loose jacket-type sheath 30 is used, the communication cable 1 can achieve a characteristic impedance of 100±10Ω even when the thickness of the insulating covering 13 of the insulated wire 11 is reduced to less than 0.25 mm, and further to 0.20 mm or less. In this case, the outer diameter of the entire communication cable 1 can be reduced to 2.5 mm or less.

Further, compared to the use of a solid jacket, the use of a loose jacket can reduce the amount of the material of the sheath 30 and consequently can reduce the mass of the communication cable 1 per unit length. As well as the above-described reduction in the diameter of the conductor 12 and reduction in the thickness of the insulating covering 13, reduction in the weight of the sheath 30 can contribute to reduction in the weight of the entire communication cable 1 and reduction in fuel consumption when the communication cable is used in an automobile.

Further, if the sheath 30 is provided as a loose jacket and there is a void G between the sheath 30 and the insulated wires 11, fusion between the sheath 30 and the insulating coverings 13 of the insulated wires 11 can be suppressed during formation of the sheath 30, for example. As a result, the sheath 30 can be easily removed when an end of the communication cable 1 is processed, for example. Fusion between the sheath 30 and the insulating coverings 13 is likely to occur particularly if the sheath 30 and the insulating coverings 13 are made of the same type of polymer material.

Note that if a loose jacket-type sheath 30 is used, the entire communication cable 1 tends to be affected by unintended flexure or bending because the sheath 30 has a tube-like shape, but this disadvantage can be compensated by using a conductor 12 that has a high strength such as a tensile strength of 380 MPa or more, or 400 MPa or more.

As the size of the void G between the sheath 30 and the insulated wires 11 increases, the effective dielectric constant (see formula (1)) decreases and the characteristic impedance of the communication cable 1 increases. In a cross section of the communication cable 1 substantially perpendicular to its axis, if the ratio of an area (outer peripheral area ratio) of the void G to an area of the whole region surrounded by an outer peripheral edge of the sheath 30, which is the cross-sectional area of a region including the sheath 30, is 8% or more, there is a sufficiently thick layer of air around the twisted wire pair 10, and accordingly a required characteristic impedance such as 100±10Ω can be easily achieved. The outer peripheral area ratio of the void G is more preferably 15% or more. On the other hand, if the ratio of the area of the void G is too large, the twisted wire pair 10 tends to be displaced in the interior space of the sheath 30 and the twist structure of the twisted wire pair 10 tends to become loose. These phenomena lead to variation or temporal change in various transmission characteristics such as the characteristic impedance of the communication cable 1. From the standpoint of suppressing these, the outer peripheral area ratio of the void G is preferably 30% or less, and more preferably 23% or less.

Instead of the above-described outer peripheral area ratio, it is also possible to use, as an index that indicates the ratio of the void G, the ratio of an area (inner peripheral area ratio) of the void G to an area of the region surrounded by an inner peripheral edge of the sheath 30, which is the cross-sectional area of a region that does not include the sheath 30, in a cross section of the communication cable 1 substantially perpendicular to its axis. The inner peripheral area ratio of the void G is preferably 26% or more, and more preferably 39% or more for reasons similar to those described above with respect to the outer peripheral area ratio. On the other hand, the inner peripheral area ratio is preferably 56% or less, and more preferably 50% or less. The void G is preferably set using the outer peripheral area ratio, rather than the inner peripheral area ratio, as an index for achieving a sufficient characteristic impedance because the thickness of the sheath 30 also has an influence on the effective dielectric constant and the characteristic impedance of the communication cable 1. However, particularly when the thickness of the sheath 30 is large, the thickness of the sheath 30 has a small influence on the characteristic impedance of the communication cable 1, and accordingly the inner peripheral area ratio can also be favorably used as the index.

There are cases where the ratio of the void G in a cross section is not the same in different portions within one pitch of the twisted wire pair 10. In such a case, it is preferable that respective average values of the outer peripheral area ratio and the inner peripheral area ratio of the void G in a length region corresponding to one pitch of the twisted wire pair 10 satisfy the above-described conditions, and it is more preferable that the outer peripheral area ratio and the inner peripheral area ratio of the void G satisfy the above-described conditions over the entire length region corresponding to one pitch of the twisted wire pair 10. Alternatively, in such a case, the ratio of the void G may be evaluated using a volume of the void in the length region corresponding to one pitch of the twisted wire pair 10 as an index. That is, in the length region corresponding to one pitch of the twisted wire pair 10, the ratio of the volume of the void G to the volume of a region surrounded by an outer peripheral surface of the sheath 30 (outer peripheral volume ratio) is preferably 7% or more, and more preferably 14% or more. The outer peripheral volume ratio is preferably 29% or less, and more preferably 22% or less. Alternatively, in the length region corresponding to one pitch of the twisted wire pair 10, the ratio of the volume of the void G to the volume of a region surrounded by an inner peripheral surface of the sheath 30 (inner peripheral volume ratio) is preferably 25% or more, and more preferably 38% or more. The inner peripheral volume ratio is preferably 55% or less, and more preferably 49% or less.

As described above, the effective dielectric constant of formula (1) decreases as the size of the void G between the sheath 30 and the insulated wires 11 increases. The effective dielectric constant depends on parameters such as the material and thickness of the sheath 30 as well as the size of the void G, and if the size of the void G and the other parameters are selected such that the effective dielectric constant becomes 7.0 or less, or more preferably 6.0 or less, the characteristic impedance of the communication cable 1 can be easily increased to a required range such as 100±10Ω. On the other hand, the effective dielectric constant is set to 1.5 or more, and more preferably 2.0 or more from the standpoint of productivity and reliability of the communication cable 1 and the standpoint of providing the insulating coverings with a predetermined thickness or more. The size of the void G can be controlled by changing the conditions (shape of the die and the point, extrusion temperature, and the like) when the sheath 30 is formed through extrusion.

As illustrated in FIG. 1, the sheath 30 is in contact with the insulated wires 11 in some regions of the inner peripheral surface of the sheath 30. If the sheath 30 firmly adheres to the insulated wires 11 in these regions, the occurrence of phenomena such as displacement of the twisted wire pair 10 in the interior space of the sheath 30 and loosening of the twist structure of the twisted wire pair 10 can be suppressed as a result of the twisted wire pair 10 being immobilized by the sheath 30. If the sheath 30 has an adhesive power of 4 N or more, more preferably 7 N or more, and further preferably 8 N or more with respect to the insulated wires 11, the occurrence of these phenomena can be suppressed and the inter-wire distance between the two insulated wires 11 can be maintained at a small value, for example, 20% or less of the outer diameter of each insulated wire 11, or substantially 0 mm, and accordingly variation and temporal change in various transmission characteristics such as the characteristic impedance can be effectively suppressed. On the other hand, an excessively large adhesive power of the sheath 30 impairs processability of the communication cable 1, and therefore the adhesive power is preferably 70 N or less. The adhesive power of the sheath 30 with respect to the insulated wires 11 can be adjusted by changing an extrusion temperature of a resin material when the sheath 30 is formed around the outer periphery of the twisted wire pair 10 by extruding the resin material. The adhesive power can be evaluated as, for example, strength that is measured when pulling the twisted wire pair 10 out of a communication cable 1 having an entire length of 150 mm in a state where the sheath 30 is removed by a length of 30 mm from one end, until the twisted wire pair 10 is removed.

Phenomena such as displacement of the twisted wire pair 10 in the interior space of the sheath 30 and loosening of the twist structure of the twisted wire pair 10 can be more easily suppressed with an increase in the area of regions where the insulated wires 11 are in contact with the inner peripheral surface of the sheath 30. These phenomena can be effectively suppressed if, in a cross section of the communication cable 1 substantially perpendicular to its axis, the ratio (contact ratio) of a length of portions in contact with the insulated wires 11 to the entire length of the inner peripheral edge of the sheath 30 is 0.5% or more, and more preferably 2.5% or more. On the other hand, if the contact ratio is 80% or less, and more preferably 50% or less, the void G can be easily formed. It is preferable that an average value of the contact ratio in a length region corresponding to one pitch of the twisted wire pair 10 satisfies the above-described conditions, and it is more preferable that the contact ratio satisfies the above-described conditions all over the length region corresponding to one pitch of the twisted wire pair 10.

The thickness of the sheath 30 can be appropriately selected. For example, the thickness of the sheath 30 is set to 0.20 mm or more, and more preferably 0.30 mm or more from the standpoint of suppressing the influence of noise from the outside of the communication cable 1, such as the influence of other cables when the communication cable 1 is used together with the other cables in the form of a wire harness or the like, and also from the standpoint of achieving mechanical characteristics of the sheath 30 such as wear resistance and impact resistance. On the other hand, the thickness of the sheath 30 is set to 1.0 mm or less, and more preferably 0.7 mm or less to reduce the effective dielectric constant and reduce the diameter of the entire communication cable 1.

As described above, the loose jacket-type sheath 30 is preferably used from the standpoint of reducing the diameter of the communication cable 1, but the solid jacket-type sheath 30′ as illustrated in FIG. 2 may be selected if the demand for the reduction in the diameter is not so strong. The solid type sheath 30′ can more firmly fix the twisted wire pair 10, and accordingly can more easily prevent phenomena such as displacement of the twisted wire pair 10 relative to the sheath 30′ and loosening of the twist structure, and consequent variation in transmission characteristics such as the capacitance of the twisted wire pair 10. As a result, it is possible to prevent temporal change or variation in various transmission characteristics such as the characteristic impedance of the communication cable 1 from being caused by these phenomena.

Whether the sheath is formed as the loose jacket-type sheath 30 or the solid jacket-type sheath 30′ and the thickness of each of the sheaths 30 and 30′ can be controlled by changing the conditions (shape of the die and the point, extrusion temperature, and the like) when the sheath is formed through extrusion. Note that the sheaths 30 and 30′ are not necessarily provided in the communication cable and can be omitted in a situation in which the twisted wire pair 10 can be protected and the twist structure can be maintained with no problems.

The sheath 30 may include a plurality of layers or may be constituted by a single layer. The sheath 30 is preferably constituted by a single layer from the standpoint of simplifying the configuration to reduce the diameter of the communication cable 1 and reduce the cost. Although the sheath 30 preferably has a dielectric loss tangent of 0.0001 or more as described above, if the sheath 30 includes a plurality of layers, the dielectric loss tangent of at least one layer is set to 0.0001 or more. It is more preferable that an average value of dielectric loss tangents of respective layers weighted with their thicknesses is 0.0001 or more, and it is further preferable that each of the layers has a dielectric loss tangent of 0.0001 or more.

A cross section of the entire communication cable 1 perpendicular to its axis, which is a region surrounded with the sheath 30, may be substantially approximate to a perfect circle or may be flatter than a perfect circle. From the standpoint of processability of the cable, the cross section is preferably approximate to a perfect circle and preferably has an oblateness of 1.15 or less, for example. On the other hand, from the standpoint of reducing the diameter of the cable and saving space, the cross section preferably has a flattened shape and preferably has an oblateness of 1.3 or more, for example. Here, the oblateness is expressed as [long diameter]/[short diameter], where the long diameter is the length of the longest of all straight lines passing across the cross section of the communication cable 1, and the short diameter is the length of the straight line that orthogonally intersects with the longest straight line at the center of the cross section. If the cross section of the communication cable 1 has a flattened shape, the outer diameter of the communication cable 1 may be defined with respect to the average of the long diameter and the short diameter, and the eccentricity ratio may be defined with respect to deviation from a designed value.

Lubricant such as talc powder may be applied to the inner peripheral surface of the sheath 30, as appropriate. Particularly in the case of the solid jacket-type sheath 30′, if the lubricant is applied to the inner peripheral surface, the sheath 30′ can be easily peeled off and removed when an end of the communication cable 1 is processed, for example. If a lubricant is used, the degree of adhesion of the sheath with respect to the insulating coverings 13 decreases, but particularly the solid jacket-type sheath 30′ can firmly hold the twisted wire pair 10 in the inside thereof owing to its shape, and accordingly the twisted wire pair 10 tends to be favorably held even when the lubricant is used.

### Examples

The following describes examples of the present disclosure. Note that the present disclosure is not limited by these examples. Unless otherwise stated, various evaluations in the examples were performed at room temperature in the atmosphere.

### [1] Verification Regarding Cross-Sectional Area of Conductor

The effect of selection of a cross-sectional area of the conductor on reduction in the diameter of the communication cable was verified. Also, the influence of a tensile strength of the conductor on the cross-sectional area of the conductor was verified.

### Production of Samples

### (1) Production of Conductor

A conductor of an insulated wire was produced. Specifically, a mixed molten metal was prepared by introducing an electrolytic copper with at least 99.99% purity and a master alloy containing Fe and Ti into a crucible made of highly pure carbon and subjecting the mixture to vacuum melting. The mixed molten metal contained 1.0% by mass of Fe and 0.4% by mass of Ti. The obtained mixed molten metal was subjected to continuous casting to form a cast material having a diameter of ø12.5 mm. The obtained cast material was extruded and rolled to ø8 mm and then drawn to ø0.165 mm. Seven strands each obtained as described above were twisted together at a twist pitch of 14 mm and then subjected to compression molding. Thereafter, thermal treatment was performed. The thermal treatment was performed at a temperature of 500° C. for 8 hours. The resultant conductor had a cross-sectional area of 0.13 mm² and an outer diameter of 0.45 mm.

The thus obtained copper alloy conductor was evaluated for its tensile strength and breaking elongation according to JIS Z 2241. The gauge length was 250 mm and the tensile speed was 50 mm/min. Evaluation results were a tensile strength of 490 MPa and a breaking elongation of 8%.

The copper alloy wire produced as described above was used as a conductor in samples A1 to A5. On the other hand, a conventionally used twisted wire made of pure copper was used as a conductor in samples A6 to A8. Tensile strength and breaking elongation evaluated as described above and cross-sectional area and outer diameter are shown in Table 1. Note that the cross-sectional area and outer diameter employed here are values that are regarded as substantially lower limits determined by restrictions regarding strength for a pure copper wire that can be used as an electric wire.

### (2) Production of Insulated Wire

An insulated wire was produced by forming an insulating covering on an outer periphery of the produced copper alloy conductor or the pure copper wire by extruding a polyethylene resin. Thicknesses of insulating coverings of the respective samples were as shown in Table 1. The eccentricity ratio of the insulated wire was 80%. The dielectric loss tangent of the polyethylene resin was 0.0002.

### (3) Production of Communication Cable

A twisted wire pair was obtained by twisting together two insulated wires each produced as described above at a twist pitch of 25 mm. The twist structure of the twisted wire pair was the first twist structure (without twirling). Then, a sheath was formed by extruding a polyethylene resin to surround an outer periphery of the twisted wire pair. The dielectric loss tangent of the polyethylene resin was 0.0002. The sheath was formed as a loose jacket-type sheath having a thickness of 0.4 mm. The outer peripheral area ratio of the void between the sheath and the insulated wires was 23% and the adhesive power of the sheath with respect to the insulated wires was 15 N. Thus, communication cables of samples A1 to A8 were obtained.

### Evaluation

### Finished Outer Diameter

The outer diameter of each of the obtained communication cables was measured to evaluate whether the diameter of the communication cable was reduced.

### Characteristic Impedance

The characteristic impedance of each of the obtained communication cables was measured. The measurement was performed using an LCR meter by an open-short method.

### Results

Table 1 shows configurations and evaluation results of the communication cables of samples A1 to A8.

TABLE 1

| | Insulated wire | | | | | | | | |
|---|---|---|---|---|---|---|---|---|---|
| | Conductor | | | | | Insulating | | Finished | |
| | | Tensile | | Cross-sectional | Outer | covering | Outer | outer | Characteristic |
| Sample | | strength | Elongation | area | diameter | thickness | diameter | diameter | impedance |
| No. | Material | [MPa] | [%] | [mm²] | [mm] | [mm] | [mm] | [mm] | [Ω] |
| A1 | Copper alloy | 490 | 8 | 0.13 | 0.45 | 0.30 | 1.05 | 2.9 | 110 |
| A2 | | | | | | 0.25 | 0.95 | 2.7 | 102 |
| A3 | | | | | | 0.20 | 0.85 | 2.5 | 96 |
| A4 | | | | | | 0.18 | 0.81 | 2.4 | 91 |
| A5 | Copper alloy | 490 | 8 | 0.13 | 0.45 | 0.15 | 0.75 | 2.3 | 86 |
| A6 | Pure copper | 220 | 24 | 0.22 | 0.55 | 0.30 | 1.15 | 3.1 | 97 |
| A7 | | | | | | 0.25 | 1.05 | 2.9 | 89 |
| A8 | | | | | | 0.20 | 0.95 | 2.7 | 80 |

The evaluation results in Table 1 show that, in comparison of samples A1 to A3, in which the conductor has a cross-sectional area of less than 0.22 mm², with samples A6 to A8, in which the conductor has a cross-sectional area of 0.22 mm², respectively, samples A1 to A3 have larger characteristic impedances although the thickness of the insulating covering is the same. The characteristic impedances of samples A1 to A3 fall in a range of 100±10Ω, which is typically required for Ethernet communication, but characteristic impedances of samples A7 and A8 are lower than the range of 100±10Ω.

The reason for the above-described behavior of the characteristic impedance is interpreted as follows. In the cases where the copper alloy wire was used as the conductor, the cross-sectional area of the conductor could be reduced and the distance between the conductors decreased compared to the cases where the pure copper wire was used. As a result, in the cases where the copper alloy conductor was used, the thickness of the insulating covering could be reduced to less than 0.30 mm, the smallest value of which being 0.18 mm, while the characteristic impedance was maintained in the range of 100±10Ω. The finished outer diameter of the communication cable was reduced by the reduction in the thickness of the insulating covering as well as by the reduction in the diameter of the conductor.

For example, sample A3 including a conductor having a cross-sectional area of less than 0.22 mm² and sample A6 including a conductor having a cross-sectional area of 0.22 mm² have substantially the same characteristic impedance. However, comparison between the finished outer diameters of these samples shows that the finished outer diameter of sample A3 including a conductor having a cross-sectional area of less than 0.22 mm² is reduced by about 20% as a result of the reduction in the diameter of the conductor.

However, even if the cross-sectional area of the conductor is less than 0.22 mm², the characteristic impedance falls outside the range of 100±10Ω if the insulating covering is too thin as in the case of sample A5. That is, a characteristic impedance in the range of 100±10Ω can be achieved by properly selecting the thickness of the insulating covering while reducing the diameter of the conductor using a copper alloy.

### [2] Verification Regarding Difference in Capacitance Between Insulated Wires

Next, the influence of a difference in capacitance between insulated wires constituting a twisted wire pair on mode conversion characteristics was verified.

### Production of Samples

Communication cables of samples A9 to A13 were produced similarly to samples A1 to A4 in the above-described experiment [1]. The cross-sectional area of the conductor of the insulated wires was 0.13 mm² and the thickness of the insulating covering was 0.20 mm. The eccentricity ratio of the insulated wire was 80% and the twist structure of the twisted wire pair was the first twist structure (without twirling). In production of samples A9 to A13, an insulating material was extruded under different production conditions to change the difference in capacitance (capacitance difference) between insulated wires in a range of 5 to 35 pF/m as shown in Table 2.

### Evaluation

The capacitance difference in each of the communication cables of samples A9 to A13 produced as described above was determined. The difference was determined by measuring capacitances of respective insulated wires with respect to a ground potential using an LCR meter at a measurement frequency of 10 MHz in an environment at 23° C., and calculating a difference between the measured capacitances. Further, the transmission mode conversion characteristic (LCTL) and reflection mode conversion characteristic (LCL) of each communication cable were evaluated using a network analyzer at a measurement frequency of 10 MHz.

### Results

The relationship between the capacitance difference and the mode conversion characteristics is shown in Table 2 below.

TABLE 2

| | Insulated wire | | | | |
|---|---|---|---|---|---|
| | Conductor | Insulating | | Transmission | Reflection |
| | cross-sec- | covering | Capacitance | mode | mode |
| Sample | tional area | thickness | difference | conversion | conversion |
| No. | [mm²] | [mm] | [pF/m] | [dB] | [dB] |
| A9 | 0.13 | 0.20 | 35 | 33 | 37 |
| A10 | | | 30 | 39 | 40 |
| A11 | | | 25 | 48 | 50 |
| A12 | | | 15 | 53 | 55 |
| A13 | | | 5 | 58 | 59 |

Table 2 shows that as the capacitance difference decreases, values of transmission mode conversion and reflection mode conversion increase, that is, the mode conversion characteristics are improved. In samples A9 and A10 in which the capacitance difference exceeds 25 pF/m, both the transmission mode conversion value and the reflection mode conversion value are less than 45 dB. In contrast, in samples A11 to A13 in which the capacitance difference is 25 pF/m or less, both the transmission mode conversion value and the reflection mode conversion value are 45 dB or more. This is presumably because changes in the waveform of a signal transmitted through the communication cable and the influence of external noise were suppressed as a result of the capacitance difference being 25 pF/m or less.

### [3] Verification Regarding Configuration of Sheath

Next, the possibility of reduction in the diameter of the communication cable by selection of the configuration of the sheath was verified.

### Production of Samples

Communication cables were produced similarly to samples A1 to A4 in the above-described experiment [1]. The eccentricity ratio of the insulated wire was 80% and the twist structure of the twisted wire pair was the first twist structure (without twirling). In production of the communication cables, two types of sheath, that is, a loose jacket-type sheath as illustrated in FIG. 1 and a solid jacket-type sheath as illustrated in FIG. 2 were prepared. Both of the sheaths were formed using a polypropylene resin (dielectric loss tangent: 0.0001). The thickness of each sheath was determined by the shape of the used die and point, and the loose jacket-type sheath had a thickness of 0.4 mm and the solid jacket-type sheath had a smallest thickness of 0.5 mm. The outer peripheral area ratio of the void between the loose jacket-type sheath and the insulated wires was 23% and the adhesive power of the sheath with respect to the insulated wires was 15 N. Also, a plurality of samples were prepared for each of the communication cables including the respective types of sheath by varying the thickness of the insulating covering of the insulated wire.

### Evaluation

Similarly to the above-described experiment [1], the characteristic impedance of each sample produced as described above was measured. Also, the outer diameter (finished outer diameter) of the communication cable and the mass per unit length were measured for some of the samples.

Additionally, transmission characteristics IL, RL, LCTL, and LCL of some of the samples were evaluated using a network analyzer.

### Results

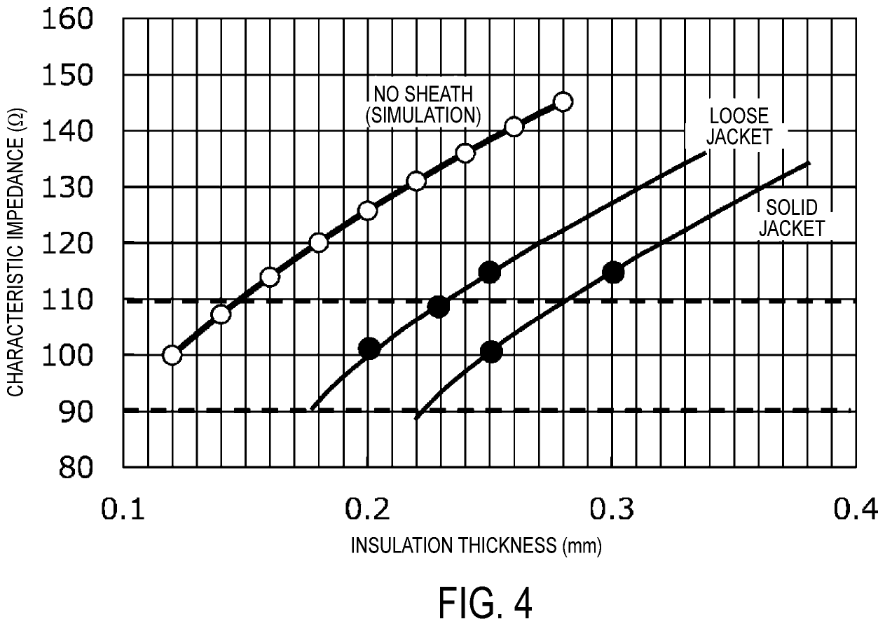

In FIG. 4, the relationship between the thickness (insulation thickness) of the insulating covering of the insulated wire and the measured characteristic impedance is plotted for the case where the sheath was the loose jacket-type sheath and the case where the sheath was the solid jacket-type sheath. FIG. 4 also shows a simulation result of the relationship between the insulation thickness and the characteristic impedance for a case where no sheath is provided. The simulation result was obtained using formula (1) (ε_{eff}=2.6), which is known as a theoretical formula of the characteristic impedance of a communication cable that includes a twisted wire pair. An approximation curve based on formula (1) is also shown for the measurement result of each of the cases including the respective sheaths. Dashed lines in the drawing indicate a range where the characteristic impedance is 100±10Ω.

The results in FIG. 4 show that in the cases where the sheath was provided, the characteristic impedance corresponding to the same insulation thickness decreased corresponding to an increase in the effective dielectric constant. However, in the case where the loose jacket-type sheath was used, the decrease was smaller compared to the case where the solid jacket-type sheath was used, and a larger characteristic impedance was achieved. In other words, the same characteristic impedance can be achieved with a smaller insulation thickness through the use of the loose jacket-type sheath.

FIG. 4 shows that a characteristic impedance of 100Ω was achieved with an insulation thickness of 0.20 mm in the case of the loose jacket-type sheath, and with an insulation thickness of 0.25 mm in the case of the solid jacket-type sheath. Table 3 below shows the insulation thickness and the outer diameter and mass of the communication cable for each of these cases.

TABLE 3

| | |
|---|---|
| Sample B1 | Sample B2 |

| | | |
|---|---|---|
| Jacket configuration | Loose jacket | Solid jacket |

| | | | | |
|---|---|---|---|---|
| Insulation thickness | 0.20 | mm | 0.25 | mm |
| Outer diameter | 2.5 | mm | 2.7 | mm |
| Mass | 7.3 | g/m | 10.0 | g/m |

As shown in Table 3, compared to the case where the solid jacket-type sheath was used, in the case where the loose jacket-type sheath was used, the insulation thickness was reduced by 25%, the outer diameter of the communication cable was reduced by 7.4%, and the mass of the communication cable was reduced by 27%. That is, it was verified that if the loose jacket-type sheath is used, a sufficient characteristic impedance can be achieved even when the insulation thickness of the insulated wire constituting the twisted wire pair is reduced, and consequently the outer diameter and mass of the entire communication cable can be reduced.

Further, transmission characteristics of the above-described communication cable (sample B1) including the loose jacket-type sheath and having an insulation thickness of 0.20 mm were evaluated, and it was found that all the following levels were satisfied, IL≤0.68 dB/m (66 MHz), RL≤20.0 dB (20 MHz), LCTL≥46.0 dB (50 MHz), and LCL≥46.0 dB (50 MHz).

### [4] Verification Regarding Size of Void

Next, the relationship between the size of the void between the sheath and the insulated wires and the characteristic impedance was verified.

### Production of Samples

Communication cables of samples C1 to C6 were produced similarly to samples A1 to A4 in the above-described experiment [1]. In production of the samples, a loose jacket-type sheath was formed using a polypropylene resin (dielectric loss tangent: 0.0001), and the size of the void between the sheath and the insulated wires was varied by adjusting the shape of the die and the point. The cross-sectional area of the conductor of the insulated wire was 0.13 mm², the thickness of the insulating covering was 0.20 mm, the thickness of the sheath was 0.40 mm, and the eccentricity ratio was 80%. The adhesive power of the sheath with respect to the insulated wires was 15 N and the twist structure of the twisted wire pair was the first twist structure (without twirling).

### Evaluation

The size of the void was measured for each sample produced as described above. At this time, the communication cable of each sample was embedded and fixed in an acrylic resin and then was cut to obtain a cross section. In the cross section, the size of the void was measured as a ratio to the cross-sectional area. In Table 4, the obtained size of the void is shown as the outer peripheral area ratio and the inner peripheral area ratio defined as described above. Further, similarly to the above-described experiment [1], the characteristic impedance of each sample was measured. In Table 4, the characteristic impedance is shown as a range because of its variation during measurement.

### Results

The relationship between the size of the void and the characteristic impedance is shown in Table 4.

TABLE 4

| | Ratio of void | | Characteristic |
|---|---|---|---|
| Sample | Outer peripheral | Inner peripheral | impedance |
| No. | area ratio [%] | area ratio [%] | [Ω] |
| C1 | 4 | 15 | 86-87 |
| C2 | 8 | 26 | 90-92 |
| C3 | 15 | 39 | 95-97 |
| C4 | 23 | 50 | 99-101 |
| C5 | 30 | 56 | 103-106 |
| C6 | 40 | 63 | 108-113 |

As shown in Table 4, characteristic impedances in the range of 100±10Ω were stably achieved in samples C2 to C5 in which the outer peripheral area ratio of the void was 8% or more and 30% or less. In contrast, in sample C1 in which the outer peripheral area ratio was less than 8%, the characteristic impedance did not reach the range of 100±10Ω because the void was too small and consequently the effective dielectric constant became too large. On the other hand, in sample C6 in which the outer peripheral area ratio exceeded 30%, the characteristic impedance became higher than the range of 100±10Ω. This result is interpreted to mean that, as a result of the void being too large, the median value of the characteristic impedance increased, and it became more likely that displacement of the twisted wire pair and loosening of the twist structure occur within the sheath, which caused a large variation in the characteristic impedance.

### [5] Verification Regarding Adhesive Power of Sheath

Next, the relationship between adhesive power of the sheath with respect to the insulated wires and temporal changes in the characteristic impedance was verified.

### Production of Samples

Communication cables of samples D1 to D4 were produced similarly to samples A1 to A4 in the above-described experiment [1]. A loose jacket-type sheath was formed using a polypropylene resin (dielectric loss tangent: 0.0001), and the adhesive power of the sheath with respect to the insulated wires was varied as shown in Table 5. The adhesive power was varied by adjusting an extrusion temperature of the resin material. The outer peripheral area ratio of the void between the sheath and the insulated wires was 23%. The cross-sectional area of the conductor of the insulated wire was 0.13 mm², the thickness of the insulating covering was 0.20 mm, and the thickness of the sheath was 0.40 mm. The eccentricity ratio of the insulated wire was 80%. The twist structure of the twisted wire pair was the first twist structure (without twirling), and the twist pitch was 8 times of the outer diameter of the insulated wire.

### Evaluation

Adhesive power of the sheath was measured for each sample produced as described above. The adhesive power of the sheath was evaluated as the strength that was measured when pulling the insulated wires out of a sample having an entire length of 150 mm in a state where the sheath was removed by a length of 30 mm from one end, until the insulated wires were removed. Also, changes in the characteristic impedance were measured under conditions created by simulating use over time. Specifically, the communication cable of each sample was bent 200 times by an angle of 90° along a mandrel having an outer diameter of ø25 mm, then the characteristic impedance of the bent portion was measured, and a change amount between before and after the bending was recorded.

### Results

The relationship between the adhesive power of the sheath and the change amount of the characteristic impedance is shown in Table 5.

TABLE 5

| | | Characteristic |
|---|---|---|
| | Sheath adhesive | impedance change |
| Sample No. | power [N] | amount |
| D1 | 15 | No change |
| D2 | 7 | Increased by 3Ω |
| D3 | 4 | Increased by 3Ω |
| D4 | 2 | Increased by 7Ω |

The results in Table 5 show that in samples D1 to D3 in which the adhesive power of the sheath was 4 N or more, the change amount of the characteristic impedance was 3Ω or less, which indicates that the characteristic impedance hardly changed through use over time simulated by the bending using the mandrel. In contrast, the change amount of the characteristic impedance reached 7Ω in sample D4 in which the adhesive power of the sheath was less than 4 N.

### [6] Verification Regarding Thickness of Sheath

Next, the relationship between the thickness of the sheath and external influence on transmission characteristics was verified.

### Production of Samples

Communication cables of samples E1 to E6 were produced similarly to samples A1 to A4 in the above-described experiment [1]. A loose jacket-type sheath was formed using a polypropylene resin (dielectric loss tangent: 0.0001), and the thickness of the sheath was varied between samples E2 to E6 as shown in Table 6. The sheath was not provided in sample E1. The outer peripheral area ratio of the void between the sheath and the insulated wires was 23%. The adhesive power of the sheath was 15 N. The cross-sectional area of the conductor of the insulated wire was 0.13 mm², and the thickness of the insulating covering was 0.20 mm. The eccentricity ratio of the insulated wire was 80%. The twist structure of the twisted wire pair was the first twist structure (without twirling), and the twist pitch was 24 times of the outer diameter of the insulated wire.

### Evaluation

The change in the characteristic impedance caused by the influence of other cables was evaluated for the communication cable of each sample produced as described above. Specifically, first, the characteristic impedance of the communication cable of each sample was measured in an independent state where the communication cable was just by itself. Also, the characteristic impedance was measured in a bundled state where the communication cable was bundled with other cables. The communication cable in the bundled state was prepared by disposing six other cables (PVC cables with an outer diameter of 2.6 mm) in contact with an outer periphery of a sample cable substantially centrosymmetrically with respect to the sample cable, and fixing the other cables by wrapping a PVC tape. An amount of change of the characteristic impedance in the bundled state relative to the characteristic impedance in the independent state was recorded.

### Results

The relationship between the thickness of the sheath and the change amount of the characteristic impedance is shown in Table 6.

TABLE 6

| | | Characteristic |
|---|---|---|
| | Thickness of sheath | impedance change |
| Sample No. | [mm] | amount |
| E1 | 0 (no sheath) | Decreased by 10 Ω |
| E2 | 0.10 | Decreased by 8 Ω |
| E3 | 0.20 | Decreased by 4 Ω |
| E4 | 0.30 | Decreased by 3 Ω |
| E5 | 0.40 | Decreased by 3 Ω |
| E6 | 0.50 | Decreased by 2 Ω |

The results in Table 6 show that the amount of change in the characteristic impedance caused by the influence of the other cables was 4Ω or less in samples E3 to E6 in which the thickness of the sheath was 0.20 mm or more. In contrast, the change amount of the characteristic impedance was as large as 8Ω or more in samples E1 and E2 in which the sheath was not provided or had a thickness of less than 0.20 mm. If a communication cable as described above is used in an automobile in the proximity of other cables in the form of a wire harness or the like, the amount of change in the characteristic impedance caused by the influence of the other cables is preferably 5Ω or less.

### [7] Verification Regarding Eccentricity Ratio of Insulated Wire

Next, the relationship between the eccentricity ratio of the insulated wire and transmission characteristics was verified.

### Production of Samples

Communication cables of samples F1 to F6 were produced similarly to samples A1 to A4 in the above-described experiment [1]. When producing the samples, the eccentricity ratio of the insulated wire was varied as shown in Table 7 by adjusting conditions of formation of the insulating covering. The cross-sectional area of the conductor of the insulated wire was 0.13 mm², and the thickness (average value) of the insulating covering was 0.20 mm. A loose jacket-type sheath was formed using a polypropylene resin (dielectric loss tangent: 0.0001). The thickness of the sheath was 0.40 mm, the outer peripheral area ratio of the void between the sheath and the insulated wires was 23%, and the adhesive power of the sheath was 15 N. The twist structure of the twisted wire pair was the first twist structure (without twirling), and the twist pitch was 24 times of the outer diameter of the insulated wire.

### Evaluation

Similarly to the above-described experiments [2] and [3], the transmission mode conversion characteristic (LCTL) and the reflection mode conversion characteristic (LCL) of the communication cable of each sample produced as described above were measured. The measurement was performed at frequencies in a range of 1 to 50 MHz.

### Results

The eccentricity ratio and measurement results of the respective mode conversion characteristics are shown in Table 7. Each value of mode conversion shown in the table is the minimum absolute value obtained in the range of 1 to 50 MHz.

TABLE 7

| | | Transmission | Reflection mode |
|---|---|---|---|
| Sample | Eccentricity ratio | mode conversion | conversion |
| No. | [%] | [dB] | [dB] |
| F1 | 60 | 47 | 45 |
| F2 | 65 | 49 | 49 |
| F3 | 70 | 52 | 54 |
| F4 | 75 | 57 | 55 |
| F5 | 80 | 59 | 57 |
| F6 | 85 | 58 | 58 |

Table 7 shows that both the transmission mode conversion and reflection mode conversion satisfied the level of 46 dB or more in samples F2 to F6 in which the eccentricity ratio was 65% or more. In contrast, this level was not satisfied by both of the transmission mode conversion and reflection mode conversion of sample F1 in which the eccentricity ratio was 60%.

### [8] Verification Regarding Twist Pitch of Twisted Wire Pair

Next, the relationship between the twist pitch of the twisted wire pair and temporal change in the characteristic impedance was verified.

### Production of Samples

Communication cables of samples G1 to G4 were produced similarly to samples D1 to D4 in the above-described experiment [5]. In production of the samples, the twist pitch of the twisted wire pair was varied as shown in Table 8. The adhesive power of the sheath with respect to the insulated wires was 70 N.

### Evaluation

Similarly to the above-described experiment [5], the change amount of the characteristic impedance was evaluated for each sample produced as described above by bending the sample using a mandrel.

### Results

The relationship between the twist pitch of the twisted wire pair and the change amount of the characteristic impedance is shown in Table 8. In Table 8, the twist pitch of the twisted wire pair is shown as a value relative to the outer diameter (0.85 mm) of the insulated wire, that is, a value that indicates the twist pitch is how many times of the outer diameter of the insulated wire.

TABLE 8

| | | Characteristic |
|---|---|---|
| Sample | Twist pitch | impedance change |
| No. | [times] | amount |
| G1 | 15 | No change |
| G2 | 30 | Increased by 3 Ω |
| G3 | 45 | Increased by 4 Ω |
| G4 | 50 | Increased by 8 Ω |

The results in Table 8 show that the change amount of the characteristic impedance was 4Ω or less in samples G1 to G3 in which the twist pitch was 45 times or less of the outer diameter of the insulated wire. In contrast, the change amount of the characteristic impedance reached 8Ω in sample G4 in which the twist pitch was more than 45 times of the outer diameter of the insulated wire.

### [9] Verification Regarding Twist Structure of Twisted Wire Pair

Next, the relationship between the twist structure of the twisted wire pair and variation in the characteristic impedance was verified.

### Production of Samples

Communication cables of samples H1 and H2 were produced similarly to samples D1 to D4 in the above-described experiment [5]. The twist structure of the twisted wire pair was the above-described first twist structure (without twirling) in sample H1 and was the second twist structure (with twirling) in sample H2. In both samples, the twist pitch of the twisted wire pair was 20 times of the outer diameter of the insulated wire. The adhesive power of the sheath with respect to the insulated wires was 30 N.

### Evaluation

The characteristic impedance was measured for each sample produced as described above. The measurement was performed three times and a variation width of the characteristic impedance between the three times of measurement was recorded.

### Results

The relationship between the twist structure and the variation width of the characteristic impedance is shown in Table 9.

TABLE 9

| | | Characteristic | |
|---|---|---|---|
| Sample | | impedance | |
| No. | Twist structure | variation width | |
| H1 | First | 3 | Ω |
| | (without twirling) | | |
| H2 | Second | 14 | Ω |
| | (with twirling) | | |

The results in Table 9 show that the variation width of the characteristic impedance was small in sample H1 in which no twirling was added to the insulated wires. This is presumably because the influence of variation in the inter-wire distance, which would otherwise be caused by the twirling, was avoided.

### [10] Verification Regarding Dielectric Loss Tangent of Sheath

Next, the relationship between the dielectric loss tangent of the sheath and mode conversion characteristics was verified.

### Production of Samples

### (1) Preparation of Insulating Materials

As materials of the sheath of the communication cable and the insulating covering of the insulated wire, insulating materials A to D were prepared by kneading components shown in Table 10 below. Magnesium hydroxide was used as a flame retardant and a hindered phenol-based antioxidant was used as an antioxidant.

### (2) Production of Communication Cable

Insulated wires to be used for samples I1 to I10 were produced by forming insulating coverings through extrusion on outer peripheries of copper alloy conductors (cross-sectional area: 0.13 mm²) produced similarly to those in the above-described experiment [1]. In samples I1 to 14, the insulating material B was used as the insulating material of the insulating covering. In samples I5 to I10, the insulating materials shown in Table 12 were used. The thickness of the insulating covering was 0.20 mm. The eccentricity ratio of the insulated wire was 80%.

A twisted wire pair was obtained by twisting together two insulated wires produced as described above at a twist pitch of 24 times of the outer diameter of the insulated wire. The twist structure of the twisted wire pair was the first twist structure (without twirling). Then, a sheath was formed by extruding an insulating material to surround an outer periphery of the obtained twisted wire pair.

The insulating material of the sheath was selected from the insulating materials A to D shown in Table 11 for samples I1 to I4 and in Table 12 for samples I5 to I10. In the communication cables of samples I1 to 14, the insulating covering of the insulated wire was made of the insulating material B and the sheath was made of the insulating materials A to D, respectively. In samples I5 to I10, the insulating covering of the insulated wire and the sheath were made of combinations of the insulating materials B to D.

The sheath was formed as a loose jacket-type sheath having a thickness of 0.4 mm. The outer peripheral area ratio of the void between the sheath and the insulated wires was 23%, and the adhesive power of the sheath with respect to the insulated wires was 15 N. The communication cables of samples I1 to 14 and samples I5 to I10 were obtained as described above.

The characteristic impedance was measured for each of the communication cables of samples I1 to I10 using an LCR meter by the open-short method, and it was found that the characteristic impedance was in a range of 100±10Ω in all of samples I1 to 110.

### Evaluation

First, the dielectric loss tangent of each of the insulating materials A to D was measured. The measurement was performed using an impedance analyzer.

Next, the transmission mode conversion characteristic (LCTL) was evaluated for samples I1 to 14 that differ from each other in the material of the sheath and accordingly differ in the dielectric loss tangent of the sheath. The measurement was performed using a network analyzer at a frequency of 50 MHz.

Further, the transmission mode conversion characteristic was similarly evaluated for samples I5 to I10 that differ from each other in their combination of materials of the sheath and the insulating covering and accordingly differ in their combination of dielectric loss tangents of the sheath and the insulating covering.

### Results

Table 10 shows measurement results of the dielectric loss tangent of the insulating materials A to D together with blend ratio of constituent materials.

TABLE 10

| | Constituent material blend ratio | | | | |
|---|---|---|---|---|---|
| | [parts by mass] | | | | |
| | Polypro- | | | Styrene- | Dielectric |
| | pylene | Flame | Antiox- | based | loss |
| Material | resin | retardant | idant | elastomer | tangent |
| Insulating | 100 | 20 | 2 | 10 | 0.0001 |
| material A | | | | | |
| Insulating | | 60 | | | 0.0002 |
| material B | | | | | |
| Insulating | | 120 | | | 0.0006 |
| material C | | | | | |
| Insulating | | 180 | | | 0.001 |
| material D | | | | | |

Table 10 shows that the dielectric loss tangent increases with an increase in the amount of filler.

Table 11 shows measurement results of the transmission mode conversion characteristic of the communication cables of samples I1 to I4 in which the sheath was formed using the above-described insulating materials A to D, respectively.

TABLE 11

| | Insulating covering | | Sheath | | Transmis- |
|---|---|---|---|---|---|
| | | Dielectric | | Dielectric | sion mode |
| | | loss | | loss | conversion |
| Sample No. | Material | tangent | Material | tangent | [dB] |
| Sample I1 | Insulating | 0.0002 | Insulating | 0.0001 | 46 |
| | material B | | material A | | |
| Sample I2 | | | Insulating | 0.0002 | 47 |
| | | | material B | | |
| Sample I3 | | | Insulating | 0.0006 | 53 |
| | | | material C | | |
| Sample I4 | | | Insulating | 0.001 | 56 |
| | | | material D | | |

Table 11 shows that transmission mode conversion satisfying the level of 46 dB or more was achieved with dielectric loss tangents of the sheath of 0.0001 or more. The value of transmission mode conversion increases with an increase in the dielectric loss tangent of the sheath.

Finally, Table 12 shows measurement results of the transmission mode conversion characteristic of samples I5 to I10 that differ from each other in their combination of materials of the sheath and the insulating covering and accordingly differ in their combination of dielectric loss tangents of the sheath and the insulating covering.

TABLE 12

| | Insulating covering | | Sheath | | Transmis- |
|---|---|---|---|---|---|
| | | Dielectric | | Dielectric | sion mode |
| | | loss | | loss | conversion |
| Sample No. | Material | tangent | Material | tangent | [dB] |
| Sample I5 | Insulating | 0.0002 | Insulating | 0.0002 | 47 |
| | material B | | material B | | |
| Sample I6 | Insulating | 0.0002 | Insulating | 0.001 | 56 |
| | material B | | material D | | |
| Sample I7 | Insulating | 0.0006 | Insulating | 0.0002 | 44 |
| | material C | | material B | | |
| Sample I8 | Insulating | 0.0006 | Insulating | 0.001 | 53 |
| | material C | | material D | | |
| Sample I9 | Insulating | 0.001 | Insulating | 0.0002 | 43 |
| | material D | | material B | | |
| Sample I10 | Insulating | 0.001 | Insulating | 0.001 | 49 |
| | material D | | material D | | |

The results in Table 12 show that the value of transmission mode conversion was smaller than 46 dB in samples I7 and I9 in which the dielectric loss tangent of the sheath was smaller than the dielectric loss tangent of the insulating covering. In contrast, the value of transmission mode conversion was 46 dB or more in samples I5 and I10 in which the dielectric loss tangent of the sheath was the same as the dielectric loss tangent of the insulating covering. In samples I6 and I8 in which the dielectric loss tangent of the sheath was larger than the dielectric loss tangent of the insulating covering, the value of transmission mode conversion was further increased and exceeded 50 dB. In comparison between samples I6 and I8, the value of transmission mode conversion was larger in sample I6, which had a larger difference in dielectric loss tangent between the sheath and the insulating covering.

### [11] Influence of Tensile Strength of Conductor on Transmission Characteristics

Next, it was verified how the tensile strength of the conductor of the insulated wire affects the characteristic impedance and mode conversion characteristics of the communication cable.

### Production of Samples

Communication cables of samples J1 to J3 were produced similarly to those in the above-described experiment [10]. However, amounts of Fe and Ti in the component composition of the conductor were varied between the samples as shown in Table 13 below. The insulating covering of the conductor was formed using the above-described insulating material B in the experiment [10] and the sheath was formed using the above-described insulating material D. Sample J1 is the same as sample I6 in the above-described experiment [10].

Evaluation

The transmission mode conversion characteristic (LCTL) was evaluated for each of the communication cables of samples J1 to J3. The measurement was performed using a network analyzer at a frequency of 50 MHz.

Further, the copper alloy conductor of each sample was evaluated for its tensile strength and breaking elongation according to JIS Z 2241. The gauge length was 250 mm and the tensile speed was 50 mm/min. Further, the characteristic impedance of the communication cable was measured using an LCR meter by the open-short method, and it was found that the characteristic impedance was in a range of 100±10Ω in all of samples J1 to J3.

### Results

Table 13 shows measurement results of transmission mode conversion in samples J1 to J3 together with the component composition and properties of the conductor.

TABLE 13

| | | | Properties of | | |
|---|---|---|---|---|---|
| | | | conductor | | Transmission |
| | Conductor composition | | Tensile | Breaking | mode |
| Sample | (% by mass) | | strength | elongation | conversion |
| No. | Fe | Ti | (MPa) | (%) | [dB] |
| Sample J1 | 1.0 | 0.40 | 490 | 8 | 56 |
| Sample J2 | 1.0 | 0.22 | 425 | 8 | 55 |
| Sample J3 | 1.0 | 0.16 | 380 | 8 | 56 |

Table 13 shows that the tensile strength changed by a change in the component composition of the conductor. Specifically, with an increase in the amount of Ti, the tensile strength was improved while the breaking elongation was maintained. However, the value of transmission mode conversion did not substantially change even though the tensile strength changed.

These results confirm that a change in the tensile strength of the conductor has no influence on electrical characteristics such as the characteristic impedance and mode conversion characteristics of the communication cable if the communication cable can be produced by properly selecting configurations such as the cross-sectional area of the conductor.

### [12] Relationship Between Breaking Elongation of Conductor and Twist Pitch

Next, the relationship between the breaking elongation of the conductor and the twist pitch of the twisted wire pair was verified.

### Production of Samples

### (1) Preparation of Insulating Materials

A material of the sheath of the communication cable was prepared by kneading 100 parts by mass of a polypropylene resin and 60 parts by mass of magnesium hydroxide added as a flame retardant. The dielectric loss tangent of this material was 0.0002. Also, a material of the insulating covering of the insulated wire was prepared by kneading 100 parts by mass of a polypropylene resin and 120 parts by mass of magnesium hydroxide added as a flame retardant. The dielectric loss tangent of this material was 0.0006.

### (2) Production of Conductor

Two types of conductors were prepared in this experiment. A conductor for samples of groups K1 to K3 was prepared using a Cu—Fe—P—Sn alloy wire, which is a soft copper wire. Specifically, a mixed molten metal was prepared by introducing an electrolytic copper with at least 99.99% purity and a master alloy containing Fe, P, and Sn into a crucible made of highly pure carbon and subjecting the mixture to vacuum melting. The mixed molten metal contained 0.61% by mass of Fe, 0.12% by mass of P, and 0.26% by mass of Sn. The obtained mixed molten metal was subjected to continuous casting to form a cast material having a diameter of o12.5 mm. The obtained cast material was extruded and rolled to o8 mm and then drawn to o0.165 mm. Seven strands each obtained as described above were twisted together at a twist pitch of 14 mm and were subjected to compression molding. Thereafter, thermal treatment was performed. The thermal treatment was performed at a temperature of 480° C. for 4 hours. The resultant conductor had a cross-sectional area of 0.13 mm² and an outer diameter of 0.45 mm. This conductor had a breaking elongation of 7%.

On the other hand, a conductor for samples of groups L1 to L3 was prepared using a Cu—Sn alloy wire, which is a hard copper wire. The Cu—Sn alloy contained 0.24% by mass of Sn and the remaining portion was Cu and inevitable impurities. The conductor was prepared similarly to the above-described case of the Cu—Fe—P—Sn alloy wire by twisting together seven strands of o0.165 mm at a twist pitch of 14 mm and subjecting the resultant twisted wire to compression molding. The obtained conductor had a cross-sectional area of 0.13 mm² and an outer diameter of 0.45 mm. The conductor had a breaking elongation of 2%.

### (3) Production of Insulated Wire

Similarly to the experiment [10], insulated wires to be used for samples of groups K1 to K3 and groups L1 to L3 were produced by forming insulating coverings with a thickness of 0.20 mm through extrusion on outer peripheries of the two types of copper alloy conductors using the insulating material prepared as described above. Each insulated wire had an outer diameter of 0.85 mm.

### (4) Production of Communication Cable

A twisted pair wire was obtained by twisting together two insulated wires each produced as described above. The twist pitch was any of the three twist pitches shown in Table 14. No twirling about the twist axis was added to the insulated wires during twisting.

Then, similarly to the above-described experiment [10], a sheath was formed by extruding the insulating material prepared as described above. The sheath was formed as a loose jacket-type sheath having a thickness of 0.4 mm. Thus, the communication cables of groups K1 to K3 and groups L1 to L3 were obtained.

The conductors of the communication cables of groups K1 to K3 were constituted by soft copper wires and the conductors of the communication cables of groups L1 to L3 were constituted by hard copper wires. The twist pitch of the twisted wire pair relative to the outer diameter of the insulated wire was 18 times in groups K1 and L1, 24 times in groups K2 and L2, and 29 times in groups K3 and L3.

### Evaluation

The characteristic impedance was measured for each of the obtained communication cables. The measurement was performed using an LCR meter by the open-short method. Five communication cables were prepared as samples (sample Nos. #1 to #5) for each of the groups K1 to K3 and groups L1 to L3, and the characteristic impedance of each sample was measured to evaluate variation between the samples.

### Results

Table 14 shows measurement results of the characteristic impedance of the communication cables of each of the groups K1 to K3 and L1 to L3. The average value of characteristic impedances of five samples and a distribution width calculated as a difference between the maximum value and the minimum value are also shown. In the table, the twist pitch of the twisted wire pair is shown as a multiple of the outer diameter of the insulated wire.

TABLE 14

| | Twist pitch | | Characteristic impedance (Ω) | | | | | | |
|---|---|---|---|---|---|---|---|---|---|
| Group | (relative to | | | | | | | | Distribution |
| No. | wire diameter) | Conductor type | #1 | #2 | #3 | #4 | #5 | Average | width |
| K1 | 18 times | Soft copper wire | 102 | 100 | 101 | 99 | 102 | 101 | 3 |
| L1 | | Hard copper wire | 103 | 105 | 101 | 100 | 103 | 102 | 5 |
| K2 | 24 times | Soft copper wire | 102 | 103 | 105 | 103 | 101 | 103 | 4 |
| L2 | | Hard copper wire | 102 | 108 | 104 | 103 | 111 | 106 | 9 |
| K3 | 29 times | Soft copper wire | 103 | 102 | 104 | 104 | 106 | 104 | 4 |
| L3 | | Hard copper wire | 103 | 106 | 110 | 104 | 112 | 107 | 9 |

Table 14 shows that, at each of the twist pitches, the average value and distribution width of the characteristic impedance were smaller when the soft copper wire having a high breaking elongation was used as the conductor than when the hard copper wire having a low breaking elongation was used. That is, a state where the characteristic impedance was not too high was stably achieved in the case where the soft copper wire was used as the conductor. This is interpreted as the result of the two insulated wires being stably twisted together with a small gap because the conductor had a high breaking elongation.

In the case where the soft copper wire was used as the conductor, values of the characteristic impedance fell in the range of 100±10Ω with a margin being left even when the twist pitch was as large as 29 times of the outer diameter of the insulated wire. On the other hand, the above results are interpreted to mean that, even if the hard copper wire is used as the conductor, a characteristic impedance in the range of 100±10Ω can be achieved by reducing the twist pitch to less than 24 times of the outer diameter of the insulated wire.

Although an embodiment of the present disclosure has been described in detail, the present disclosure is by no means limited to the above-described embodiment, and various alterations can be made within a scope not departing from the gist of the present disclosure.

As described above, the sheath covering the outer periphery of the twisted wire pair is not limited to a loose jacket-type sheath, and a solid type sheath may be employed depending on the degree of demand for reduction in the diameter of the communication cable. The sheath is not limited to the loose jacket-type sheath and the solid type sheath that have a tube-like shape. The sheath may be formed by wrapping a flexible elongated insulator, such as a tape, string, or band, around the outer periphery of the twisted wire pair. A shield may be provided inside the sheath. Alternatively, the sheath may be omitted. In any of the above-described cases, it is possible to apply, to respective portions of the communication cable, preferable configurations similar to those described above, such as material, thickness, and dielectric loss tangent of the insulating covering, component composition, tensile strength, breaking elongation, and resistance of the conductor, outer diameter, eccentricity ratio, friction coefficient, and capacitance difference of the insulated wire, twist structure, twist pitch, presence or absence of the sheath, configuration, material, thickness, adhesive power, dielectric loss tangent, and shrinkage ratio of the sheath, and outer diameter and breaking strength of the communication cable. If the above-described preferable configurations applicable to respective portions of the communication cable are appropriately combined with a configuration of a communication cable that includes a twisted wire pair obtained by twisting together a pair of insulated wires each including a conductor having a cross-sectional area of less than 0.22 mm² and an insulating covering on an outer periphery of the conductor and that has a characteristic impedance in a range of 100±10Ω, it is possible to obtain a communication cable that has characteristics imparted by respective configurations, as well as a required characteristic impedance and a reduced diameter.

Note that it is possible to consider using a conductor having a cross-sectional area of 0.22 mm² or more if the demand for the reduction in the diameter of the communication cable is not so strong. In some cases, a characteristic impedance of a value out of the range of 100±10Ω is required. In those cases, from the standpoint of providing a communication cable excellent in transmission characteristics, it is possible to apply any one or combination of the above-described preferable configurations, such as material, thickness, and dielectric loss tangent of the insulating covering, component composition, tensile strength, breaking elongation, and resistance of the conductor, outer diameter, eccentricity ratio, friction coefficient, and capacitance difference of the insulated wire, twist structure, twist pitch, presence or absence of the sheath, configuration, material, thickness, adhesive power, dielectric loss tangent, and shrinkage ratio of the sheath, and outer diameter and breaking strength of the communication cable, to respective portions of a communication cable that includes a twisted wire pair obtained by twisting together a pair of insulated wires each including a conductor and an insulating covering on an outer periphery of the conductor. As a result, a communication cable that has excellent transmission characteristics according to employed configurations can be obtained.

Although the present specification has been described mainly regarding a case where the communication cable includes a twisted wire pair obtained by twisting together two insulated wires that transmit signals, the above-described preferable configurations are also applicable to respective portions of a communication cable that includes two insulated wires that extend side-by-side without being twisted together or a communication cable in which the number of insulated wires twisted together is not two, such as four.

1. A communication cable comprising:
a communication line that includes a pair of insulated wires that each include a conductor that has a cross-sectional area of less than 0.22 mm² and an insulating covering that covers an outer periphery of the conductor,
wherein the communication cable has a characteristic impedance in a range of 100±10Ω, and
a difference in capacitance between the insulated wires forming the communication line is 25 pF/m or less.

2. The communication cable according to claim 1,
wherein the communication line is a twisted wire pair formed by the pair of insulated wires that are twisted together.

3. The communication cable according to claim 1, further comprising:
a sheath that is made of an insulating material and covers an outer periphery of the communication line,
wherein there is a void between the sheath and the insulated wires forming the communication line.

4. The communication cable according to claim 3,
wherein in a cross section across an axis of the communication cable, the ratio of an area of the void to an area of a region surrounded by an outer peripheral edge of the sheath is 8% or more.

5. The communication cable according to claim 3,
wherein in a cross section across an axis of the communication cable, the ratio of an area of the void to an area of a region surrounded by an outer peripheral edge of the sheath is 30% or less.

6. The communication cable according to claim 3,
wherein adhesive power of the sheath with respect to the insulated wires is 4 N or more.

7. The communication cable according to claim 3,
wherein the sheath has a dielectric loss tangent of 0.0001 or more.

8. The communication cable according to claim 3,
wherein the sheath has a dielectric loss tangent that is larger than a dielectric loss tangent of the insulating covering.

9. The communication cable according to claim 1,
wherein the insulating covering has a dielectric loss tangent of 0.001 or less.

10. The communication cable according to claim 1,
wherein the conductor of each of the insulated wires has a tensile strength of 380 MPa or more.

11. The communication cable according to claim 1,
wherein the insulating covering of each of the insulated wires has a thickness of 0.30 mm or less.

12. The communication cable according to claim 1,
wherein each of the insulated wires has an outer diameter of 1.05 mm or less.

13. The communication cable according to claim 1,
wherein the communication line is a twisted wire pair formed by the pair of insulated wires that are twisted together, and
a twist pitch of the twisted wire pair is 45 times or less of an outer diameter of each of the insulated wires.

14. The communication cable according to claim 1,
wherein the conductor of each of the insulated wires has a breaking elongation of 7% or more.

15. The communication cable according to claim 14,
wherein the communication line is a twisted wire pair formed by the pair of insulated wires that are twisted together, and
a twist pitch of the twisted wire pair is 15 times or more of an outer diameter of each of the insulated wires.

16. The communication cable according to claim 1,
wherein the communication line is a twisted wire pair formed by the pair of insulated wires that are twisted together,
the conductor of each of the insulated wires has a breaking elongation of less than 7%, and
a twist pitch of the twisted wire pair is 25 times or less of an outer diameter of each of the insulated wires.

17. The communication cable according to claim 1,
wherein the conductor of each of the insulated wires is a twisted wire that includes:
a strand made of a first copper alloy that contains 0.05% by mass or more and 2.0% by mass or less of Fe, 0.02% by mass or more and 1.0% by mass or less of Ti, 0% by mass or more and 0.6% by mass or less of Mg, and a remaining portion including Cu and inevitable impurities, or
a strand made of a second copper alloy that includes 0.1% by mass or more and 0.8% by mass or less of Fe, 0.03% by mass or more and 0.3% by mass or less of P, 0.1% by mass or more and 0.4% by mass or less of Sn, and a remaining portion including Cu and inevitable impurities.
